(19) United States
(12) Patent Application Publication
(10) Pub. No.: US 2026/0111670 A1
(43) Pub. Date: Apr. 23, 2026

(54) NATURAL INTELLIGENCE FOR NATURAL LANGUAGE PROCESSING

(71) Applicant: Drexel University, Philadelphia, PA (US)

(72) Inventors: Jake Ryland Williams, Philadelphia, PA (US); Hunter Scott Heidenreich, Johns Island, SC (US); Munif Ishad Mujib, Oakland, CA (US)

(73) Assignee: Drexel University, Philadelphia, PA (US)

(21) Appl. No.: 19/117,258

(22) PCT Filed: Oct. 3, 2023
(86) PCT No.: PCT/US2023/075852

§ 371 Date: Mar. 31, 2025

Related U.S. Application Data
(60) Provisional application No. 63/378,122, filed on Oct. 3, 2022.

(51) Int. Cl. G06F 40/284; G06F 40/30; G06N 3/048; G06N 3/0499

(52) U.S. Cl. CPC G06F 40/284; G06F 40/30; G06N 3/048; G06N 3/0499

(57) ABSTRACT

Backpropagation enabled neural network optimization, but is still expensive at scale. An efficient alternative for neural networks must reduce scaling costs and provide high-efficiency optimizations. The presented solution for feed-forward layers is extended compositionally, for transformers containing feed-forward and self-attention layers. These train complex models modularized by self-attentive feed-forward units (SAFFUs), defining efficient architectures that generalize over much less data. Results demonstrate outperformance of backpropagation (alone), compared to application of backpropagation after explicit solutions, which uncover better optima from less data. Ablations train a roadmap of 245 transformers to determine specifications for the SAFFU-transformer, showing several architectural variants appear quite performant. The most performant models appear to not be the most parameterized. Summarizing, well-generalized SAFFU models are efficiently reachable, their architectural explorability via explicit solutions is cheaper and more robust than by backpropagation, and their explicit solutions could be useful for low-resource hardware, where AI might be embodied.

### BACKGROUND

Word embedding algorithms serve as crucial tools for understanding the semantics of categorical features in natural language processing (NLP) and deep learning (DL). Moreover, they continue to form an integral component of modern large language modeling (LLM) systems, since the initial step that LLMs, too, must approach is the efficient representation of tokens by static embeddings. Before the advent of transformer architecture, it was research on pre-trained word embedding techniques that enabled DL for NLP. Pioneered by Mikolov, word2vec ushered in NLP's era of representation learning, using the continuous bag-of-words and skip-gram models to demonstrate that it was possible to learn meaningful, low-dimensional representations with limited resources by predicting co-occurring tokens.

To accelerate learning via summary statistics, GloVe was ultimately introduced to harness the global statistics of co-occurrences, and moreover, without the use of contrastive learning. From there, there was ultimately a pivot to the modeling of sub-word information in a word2vec-like variant called FastText that guided further pre-transformer advances, until eventually turning to integrally learning representations for sub-word pieces, as a part of a given neural architecture. The ongoing reliance of embeddings, including by transformers, as a basis for input representation across NLP leaves us to ask whether further improvements can instead be made to the objective and optimization of embedding and their surrounding architectures, as opposed to their granularity of application.

Questions like this seem obscure with the arrival of the transformer, since the research paradigm has shifted from using pre-trained word embeddings, themselves, for transfer learning, as opposed to the more nuanced contextual′ representations, defined by the hidden states of transformers, of which modern embeddings are only a part. This shift saw the emergence of powerful models such as BERT, ELMo, and GPT, all of which relied on training LLMs to generate even higher-performance representations of words that demonstrate greater nuance at prediction of downstream tasks, in addition to their pre-training. However, this only furthers our resolve to study embeddings as a basis for understanding more complex models, like transformers, since transformer embedding layers are integral to LLM architectures-they all require some form of embedding and would otherwise not function.

### Generations and Types of Pre-Trained Word Embeddings

Representation learning in NLP has gone through many large transitions, starting from static word vectors, and into contextual word representations, and now the predominant large language models. These trends have often been based around architectural shifts, to/from the ubiquity of recurrent neural networks, and then into reliance on attention mechanisms, and the subsequent proliferation of self-attention leading to transformer-based LLMs.

### Analysis of Neural Embeddings and Connections to Explicit Solutions

In the domain of neural language processing—including pre-trained word embeddings—optimization methods are the essential algorithms that navigate the learning needed for a network to function. Like other neural components, early word embedding methods, e.g., word2vec used gradient descent-based strategies to maximize model likelihood. While GloVe refined the cost function to global word co-occurrence statistics, steps were ultimately not taken further to leverage the knowledge on matrix factorization that these more-explicit embedding methods could offer via formulation over globally known statistics. Instead—and despite its effectiveness—GloVe's approach via explicit statistics was ultimately viewed as limited by its use of a ‘simple’ co-occurrence statistics to capture context.

Significant developments studying the optimization of pre-trained word embeddings have demonstrated that word2vec's skip-gram model with negative sampling implicitly executes matrix factorization on a word-context matrix which represents the pointwise mutual information (PMI) of the respective word-context pairs, emphasizing the critical role of matrix factorization, underlying model optimizations. This idea led us to ask if understanding explicit forms—like the PMI-based word embeddings word2vec—could be computed more efficiently and effectively to encapsulate meaningful semantics.

Regardless of whether subword embeddings are used, or, e.g., if embeddings are a part of larger architecture, their computation from summary statistics are much less costly than iterative, gradient-based strategies. Moreover, understanding explicit forms for low-level components—like embeddings-could lead to more impactful knowledge on down-stream neural layers.

### Dimensionality Reduction, Alongside Embedding

Along semantic representation, word embeddings greatly advanced the standards for dimensionality reduction in language processing systems and beyond. Traditional techniques, such as PCA and SVD, may continue to be useful as low-cost or first strategies to transform high-dimensional data into more-manageable, low-dimensional spaces, alongside more recent methods, like Kernelized Matrix Factorization (KMF) that perhaps rejuvenate traditional approaches to matrix factorization. Thus, since efforts began elucidating deep connections between word representation algorithms and co-occurrence matrix factorizations, it has been a tantalizing thought to consider if BERT and other transformer-based LLMs could be similarly-well understood, being that they still rely on the same dimensionality reduction techniques within their architectures to capture word semantics.

Methods that involve the training of neural networks to accomplish dimensionality reduction produce largely-inscrutable statistical spaces while compressing dimensions. Less-random methods that explicitly reduce dimensions based on a controlled statistical process, and without the randomness incurred by neural network initializations, would greatly improve states of the art.

Concerns with AI and the Advancement they Bring

Despite making impressive strides in AI, our collective understanding of the inner workings of these models is far from complete. The absence of a comprehensive understanding of their internal mechanisms impedes our ability to fully exploit their capabilities while simultaneously raising various challenges. One of the primary concerns is the reliability and safety of these models. LLMs are prone to generating biased and unreliable text, while diffusion models may produce distorted images that conflict with basic human perception. The unpredictable behaviors of these models in novel or unusual situations challenges their operational benefits to humans via their (in) abilities to avoid inadvertent harms. Concurrently, efficiency is another major concern. Backpropagation is their predominant training and optimizing method, and entails a high computational cost, particularly as models scale up their iterative gradient computations for optimization. Training such large models requires a substantial amount of data, also necessitating significant efforts in data processing.

### Contemporary Efforts Advancing Transformer Model Architectures

Explicit solutions relate to other recent efforts focused on aspects of self-attention and transformers, e.g. finding that attention layers converge in direction to SVM solutions and that transformers may rediscover standard estimation algorithms. Explicit solutions also connect to recent discoveries finding generalization in overparametrized networks occurs beyond the point of dataset memorization. Likewise, this is also connected to efforts aimed at improving the overall training efficiency of transformers, such as one attention type developed to reduce memory reads/writes between GPU high bandwidth memory and on-chip.

### A Resolve for Explicit Solutions to Understand What's Being Learned

In light of these challenges, how can we ensure that these models are reliable, interpretable, and efficient? We posit that understanding the optimization processes underlying these models is crucial. Perhaps, grasping the intricacies of model optimization will allow for a more straightforward approach, requiring fewer iterations to achieve the same or better quality results? Furthermore, understanding how models optimize allows us to adjust specific parameters in the weight matrices, enabling models to perform in a desired manner. The inventors extended an investigation—that first analyzed single-layer feed-forward neural networks—to an architecture with both feed-forward and self-attention layers. They show simple and complex “explicit solution” optimizations for a variety of architectural variants, demonstrating general techniques that significantly accelerates model training processes beyond the capability of backpropagation alone. Remarkably, however, they find that when these solutions are applied to self-attention networks, they not only accelerates training, but moreover, generally find a vastly better optima, with greater generalization qualities. Thus, explicit optimization offers a vital alternative to the current trends in neural network training.

### SUMMARY OF THE EMBODIMENTS

The inventors have found the following: 1) the computational costs of training LLMs are substantial and obtaining contextual representations are essentially a by-product rather than the main objective of training LLMs. 2) Due to the cost-intensive nature of training LLMs via the iteratively-applied, gradient-based optimization techniques that rely upon backpropagation to mitigate computational costs, there is an inherent non-ideal trade-off between optimal performance and cost-effectiveness in them. 3) For low-resource languages, where data is limited, practitioners may still revert to more-basic methods that don't require as much data to advance their systems. 4) The methods for dimensionality reduction that are used by LLMs render models largely inscrutable, while explicit solutions for previous-generation “word embedding” layers are already largely known, and could greatly speed up and/or reduce the costs of training the larger models that rely upon them by using the explicit solutions for pre-training.

The inventors address points (1)-(4) by A) introducing the bit-cipher algorithm for dimensionality reduction, B) deriving the explicit solution for single-layer feed-forward neural networks, and C) extending the single-layer explicit solution to a compositional solution that co-optimizes attention and feed-forward layers. The A) bit-cipher algorithm is a simple technique capable of representing words in a highly efficient manner, which generalizes one-hot, i.e., standard basis word vectors to produce identifying vectors of lower dimensions.

The invention B) develops new optimization capability by exploiting knowledge of explicit solutions; the log-co-occurrence matrices that the parameters of various embedding methods such as GloVe and word2vec converge towards are much cheaper to compute interative-gradient optimization when A) dimensions are explicitly reduced. Not only are C) compositional solutions for interacting parameter deductibly accessible by extension of single-layer problem solving techniques, they produce emergent generalization behaviors in models that don't manifest without large volumes of training data. Throughout its development in experiments, the invention has integrated contextual information via two different methods based on the summation (Sum) and concatenation (Cat) of co-occurrent information.

For developing pre-trained word embeddings, the inventors' investigations found that integrating the bit-cipher with concatenation-based vector aggregation over a large window size perform competitively when compared to GloVe and word2vec on Part-of-Speech (POS) tagging and Named Entity Recognition (NER) tasks, often out-performing both. Furthermore, the efficiency of this approach allowed performance of scalability experiments spanning 100 model architectures, one fifth of which were trained on 8-billion tokens-a feat that would have been impossible if training GloVe and/or word2vec models using same resources. Finally, since bit-cipher methods are explicit, the inventors emphasize that they retain a high degree of interpretability.

The inventors' investigation was grounded in the study of two variants of the word2vec model: the continuous bag-of-words (CBOW) and skip-gram (SG) models. These models were chosen due to their simplicity, as well as the intriguing possibility of deriving explicit optimization through exploration the relationship between them. An analysis revealed that the optimized parameters of the CBOW model relied upon similar statistics to an existing explicit solution for the SG model. By taking this analysis one step further, and generalizing its outcome for single-layers of neural networks, the inventors have opened an new and broadly-applicable method that could be used across other subfields in AI.

In this disclosure, the inventors generalized their investigatation by starting from a simple form of neural network: the single-layer feed-forward neural network. They proposed an “explicit” optimization of it, and argued that explicit optimization offers a vital alternative to the current trends in neural network training. By providing a computationally efficient and interpretable method of optimization, this approach has the potential to significantly accelerate progress in the field of AI.

To substantiate the proposed solutions to parameter optimization, the inventors conducted computational experiments on language modeling and digit classification to demonstrate their near-optimal performance. Their findings for single-layer models indicates that iterative optimization (requiring backpropagation) only marginally improves upon the parameters of the explicit solution, and that randomly initialized parameters (without explicit optimization) generally converge towards lower-quality solutions. By following a similar experiment to language modeling tests, they also conduct preliminary evaluations on the MNIST image classification dataset. Their results not only transferred to image classification-demonstrating the encouraging usage of explicit optimizations outside of NLP—but demonstrated a strategy that ultimately led to neural models finding better solutions through backpropagation after explicit solutions are applied, while retaining model interpretability. These findings underscored the potential of explicit optimization as a viable and efficient method for more complex, multi-layer models.

### BRIEF DESCRIPTION OF THE DRAWINGS

FIG. 1.1 shows a 5-bit example, carried out over its largest vocabulary size of 25−1=31 vectors (rows). Vectors are allocated in numerical order, from 1 to 31 as per the algorithm depicted in FIG. 1.2.

FIG. 1.2 shows the Bit-Cipher algorithm.

FIG. 1.3 shows a comparison between how the performance of the Cat and Sum models in the POS experiment changes with the change in data size and Bits with setting radius=4.

FIG. 1.4 shows a comparison between how the performance of the Cat and Sum models in the NER experiment changes with the change in data size and Bits with setting radius=4.

FIG. 1.5 shows Table 1.1 that shows a comparison of a 300-dimensional word2vec model against 200-dimensional models (all others) on probing experiments. Note: both of GloVe and word2vec were pre-trained externally using a larger radius of 10, by comparison to the Sum and Cat models presented, which were trained using r=4. (values in the table are shown as accuracy with F1-score in Parentheses).

FIG. 1.6 shows Table 1.2, which shows data for 60 Sum models of bit-cipher on POS tagging probing experiments.

FIG. 1.7 shows Table 1.3, which shows data for 60 Sum models of bit-cipher on NER tagging probing experiments.

FIG. 1.8 shows Table 1.4, which shows data for 20 Cat models of bit-cipher on NER tagging probing experiments.

FIG. 1.9 shows Table 1.5, which shows data for 20 Cat models of bit-cipher on POS tagging probing experiments.

FIG. 1.10 shows Table 1.6, which shows data for 20 Cip models of cipher on its own on POS probing experiments.

FIG. 1.11 shows Table 1.7, which shows data for 20 Cip models of cipher on its own on NER probing experiments.

FIG. 2.1a shows The Cat and Sum models are equivalent when r=1 (depicted), and for this case the scatter plot shows the scaling relationship between unigram frequency: f₁=ΣNⱼ=1 F_{i,j} and the power mean of geometric averages of in-neighborhood co-occurrences, spanning the entire training data set

FIG. 2.1b shows training set loss curves from iterative optimization in the case of cold (random parameters) and warm (explicit solution parameters) start for the Cat model. Axes depict the perplexity as a function of epoch (iteration) on a logarithmic scale for a total of 32 epochs.

FIG. 2.2a Shows cold- and warm-start models for the MNIST data set and task for 1- and 2-layer models.

FIG. 2.2b shows a scan comparing model accuracy by normalization parameter.

FIG. 2.5 shows Table 2.1: Training (T) and development (D) set perplexities from language modeling experiments for the Sum and Cat models.

FIG. 3.1a exhibits an architecture diagram for the organization of radial and block SAFFU layers with embeddings, and demonstrates the cat model for hidden state aggregation to produce an encoder, underneath its final feed-forward decoder layer.

FIG. 3.1b compares cold-start (Cold train/dev) curves were obtained via backpropagation on randomly initialized parameters against warm-start (Warm train/dev) curves, which were obtained by first tuning the model with its explicit solution, and then applying backpropagation.

FIG. 3.2 show Tables. 3.1-3.5, which ablate varying architectural specifications across the training and development-sets to determine perplexities as a means to guide towards a most effective ‘best’ model.

### DETAILED DESCRIPTION OF THE EMBODIMENTS

1. Bit-Cipher: Method for Learning Word Representations
1.1 Bit-Cipher
1.1.1 Definition

Standard-basis encoding is unavoidable for NLP applications, as one must always encode tokens from a given model's vocabulary: W. This makes dimensionality reduction necessary for NLP applications, as the combinatorial overhead on the model parameters required to process |W|-dimensional hidden states becomes tremendous inside the models. While dimensionality reduction can be handled via gradient-based optimization in DL systems, the random nature of DL optimization obfuscates the meaning of low dimensions. However, it is possible that a similar and explicit encoder-decoder-style factorization of standard-basis information exists.

Supposing that each token t in W has an identity modified from the usual one-hot/standard-basis vector as follows: 1) select a ‘low’ dimension: b≤|W|, and 2) assign a unique bit vector, ηₜ∈ {0,1}^{b} to each. The inventors base their approach on a distinguishability hypothesis: which expects that a ‘good’ order for the bits distinguishes the highest-frequency tokens best, and has latitude to assign similar-frequency tokens similar vectors. Working along these lines, the inventors define b-bit encipherment as the process of assigning probabilistically normalized b-bit vectors in a ‘smooth’ order, by inducting the order that i=1: assigns the set of b standard basis vectors: V₁^{b} to the b most frequent tokens (generalizing one-hots/standard bases); i=2: adds standard-basis vectors to those from Vₖ₋₁^{b} in reverse order of assignment, while filtering for unique bit-vectors in {0,1}^{b}; i=3: repeats step i=2. b-bit vectors are then normalized for encipherment: Vₜ=ηt/∥ηt∥₁.

### 1.1.2 Modeling Noise in Observations

To assure that co-occurrence matrices are dense, we first modify the base representation of the model from sparse, one-hot (standard basis), to dense vectors of the same size. We first form a model: β ∈ (0, 1) N, for the portion of time that each i-token's observations are (non-) erroneous. Assuming that the highest-frequency tokens will be the least erroneously observed, we assume that only one error will be observed relative to each token's observed frequency, that is: βᵢ=fᵢ/(fᵢ+1). Next and regardless of the token that is observed, we wish to modify its one-hot vector according to the probabilities that any different, j-token, should have been observed, instead, which will take the form of another vector: σ ∈(0, 1) N, but which is normalized: ∥σ∥₁=1, and so define these other-token observation probabilities as: σⱼ=(1−fⱼ/M)/(N−1). To understand σ intuitively, we first note that 1 minus each token's unigram probability: 1−fⱼ/M expresses the probability of each token not being observed. Hence, the model σ assumes that these (non-mutually exclusive) probabilities weight a distribution for the other token that should′ve been observed. For each one-hot vector, yᵢ, we then pull together these pieces to define noisy/dense vectors as: νᵢ=βᵢyᵢ+(1−βᵢ), which form the embedding layers used in all language modeling architectures.

### 1.1.3 Implementation of the Bit-Cipher

Bit-cipher is an encoding strategy specifically designed to address the challenges faced in NLP applications regarding the vast dimensionality of token vocabularies. Its implementation involves explicit encoder-decoder-style factorization of standard-basis information.

The algorithm commences by assigning each token t in the vocabulary W a unique bit-vector ηt in {0, 1}^{b} through the process of b-bit encipherment. This effectively assigns low-dimensional, probabilistically normalized b-bit vectors to each token in a smooth order. The algorithm employs a simple yet powerful strategy whereby vectors are assigned to tokens based on their unigram frequencies. This approach grants priority to high-frequency tokens, under the assumption that an optimal arrangement of bits will yield the most effective differentiation between these tokens. Moreover, it capitalizes on the capacity to assign analogous vectors to tokens exhibiting similar frequencies.

The implementation of the bit-cipher algorithm requires careful orchestration of multiple steps. It starts by initializing sets for differently-normed bit-vectors, after which it seeks to find the next norm-k (or k+1) bit-vector. The norm of this vector should be k, and the vector itself should not have been previously used. Once this condition is met, the algorithm normalizes the bit-vector and assigns it. When the set of k-1-bit vectors no longer has any unassigned i-component modifications, the basis vector/component of modification must be incremented. Furthermore, if all last-component modifications have been applied, it means there are no unassigned k-bit vectors left, indicating the need for a reversal of the k-bit vector order to maintain smooth transitions of discernability upon future assignments.

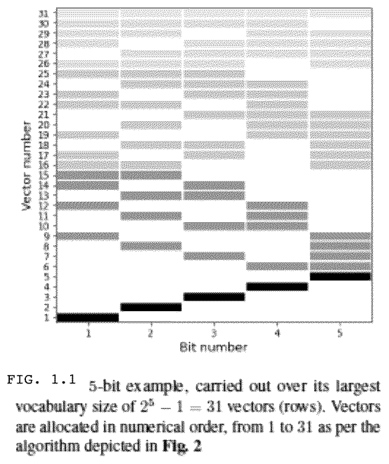

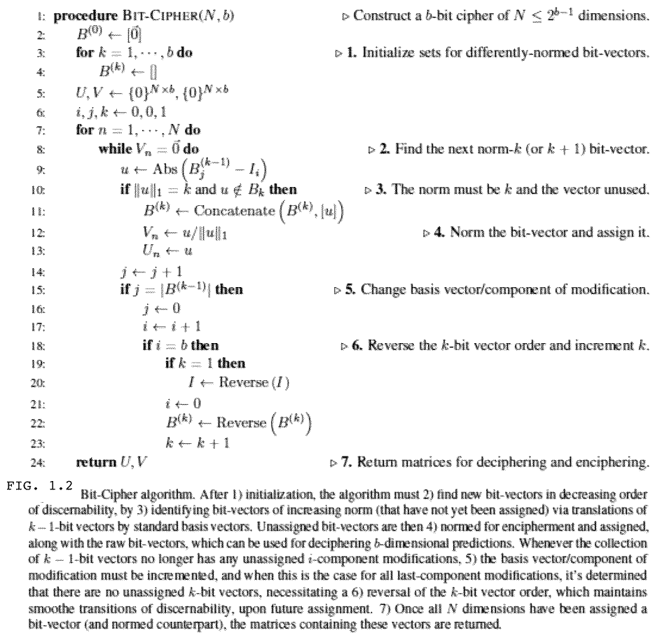

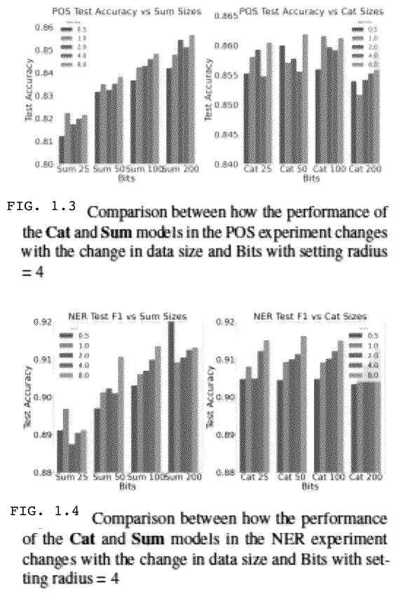

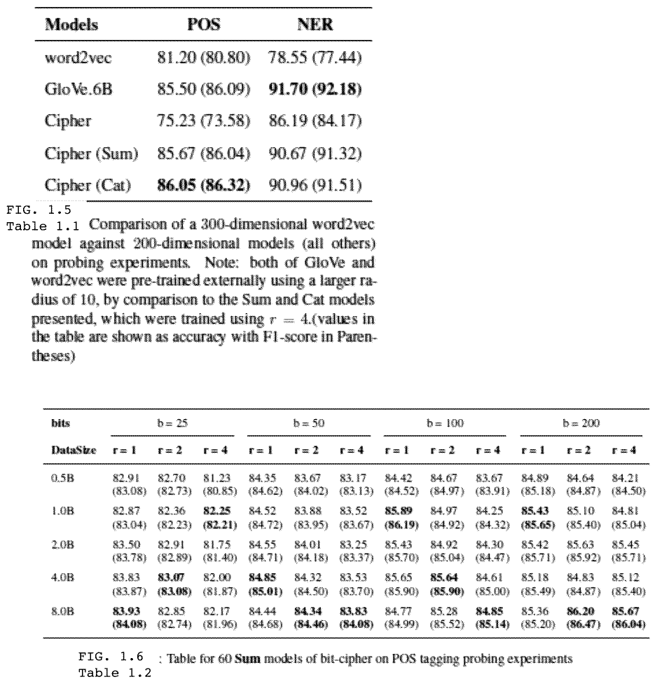

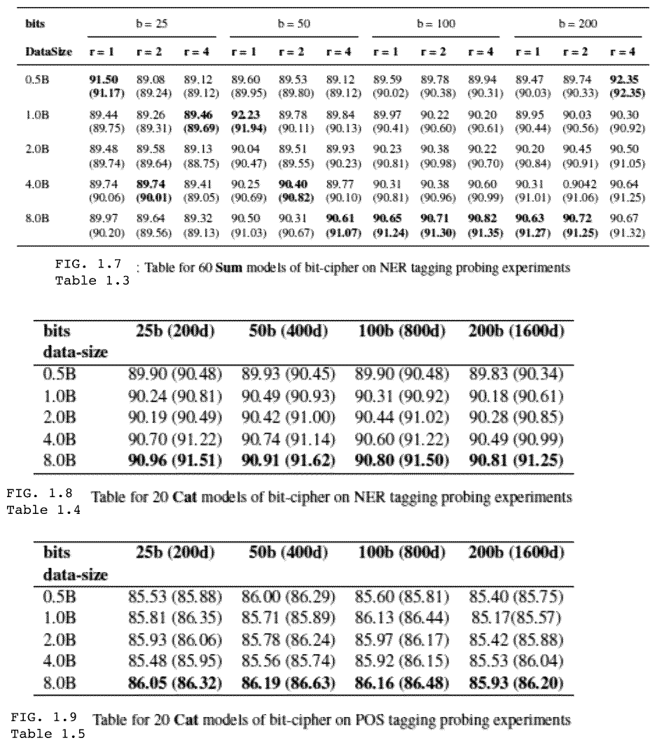

Note: Bit-cipher uses word-level information to get pre-trained embeddings as discussed herein. FIG. 1.1 presents a simple visualization that intuitively demonstrates the concept of allocating b=5 to represent 2⁵−1 unique vectors. Each vector has a dimension of 5, corresponding to the number of bits, following the implementation of the algorithm. A detailed bit-cipher algorithm implementation flowchart is shown in FIG. 1.1 that could be referred as a valuable resource for in-depth exploration and analysis.

The algorithm also considers noise in observations by modifying the base representation of the model from dimensionality-reduced one-hot vectors to dense and information-rich vectors of the same size. This is achieved by first defining a model, β in (0, 1) N, for the portion of time that each i-token's observations are non-erroneous, and then defining a vector σ ∈ (0, 1)N that's normalized such that |σ|1=1. This vector σ represents probabilities that any different, j-token, should have been observed instead of the i-token. For each one-hot vector yᵢ, the algorithm defines noisy/dense vectors as νᵢ=βᵢyᵢ+(1−βᵢ)σ, which forms the embedding layers used in all language modeling architectures.

### 1.1.4 Cipher Training Detail

The inventors trained their models on the CommonCrawl dataset, utilizing various data scales and two principal methods for aggregating contextual information: concatenation (referred to as Cat) and summation (Sum). These methods are informed by the core controlled hyperparameter bits which sets the dimension of word vectors, and two other critical parameters: log=True and dtype=′df. The logarithmic scaling parameter log=True improves sensitivity towards less frequent, yet potentially more informative words. This is beneficial as natural language often exhibits skewed distribution in terms of word occurrence frequencies and useful in learning representations. The dtype=′df parameter, on the other hand, tunes the noise level based on each word's document frequency. This adjustment enhances the model's focus on distinctive, informative words rather than on high-frequency ones, mitigating potential biases.

The presented bit-cipher models were trained on five different scales of data-size: 0.5B-token, 1B-token, 2B-token, 4B-token, and 8B-token with setting up different radius (window size) and bits. Through incremental increase of the data-size, we aim to understand how model performance adjusts with the intake of more data. Although this data-size range is relatively small compared to other pre-trained word embedding methods, like GloVe trained with 42B and 840B tokens and word2vec trained on Google News with 100B tokens. All that is being said, the efficiency of bit-cipher as a means of learning representation may be corroborated through a series of probing experiments below.

In them, the inventors followed the simplest preprocessing procedure by tokenizing all the text using the standard spaCy tokenizer, followed by converting all the tokens to lowercase. The main training procedure itself includeed two steps. The initial phase adheres to the algorithm showing the steps detailed in FIG. 1.2.
After 1) initialization, the algorithm
2) finds new bit-vectors in decreasing order of discernability, by
3) identifying bit-vectors of increasing norm (that have not yet been assigned) via translations of k-1-bit vectors by standard basis vectors. Unassigned bit-vectors are then
4) normed for encipherment and assigned, along with the raw bit-vectors, which can be used for deciphering b-dimensional predictions. Whenever the collection of k-1-bit vectors no longer has any unassigned i-component modifications,
5) the basis vector/component of modification must be incremented, and when this is the case for all last-component modifications, it's determined that there are no unassigned k-bit vectors, necessitating a
6) reversal of the k-bit vector order, which maintains smooth transitions of discernability, upon future assignment.
7) Once all N dimensions have been assigned a bit-vector (and normed counterpart), the matrices containing these vectors are returned.
yielding the original versions of bit-cipher representations, the directly generated representations are noted as Cip in following probing experiments. The second phase focuses on integrating contextual information into each word representation using either the Cat or Sum methods.

For Cat models, bits are set at 25, 50, 100, and 200, respectively, while maintaining a fixed radius of 4, as a largest window size setup in all models' training; the larger the radius, the more contextual information that's provided. With these configurations, we obtain representation lengths of 200d, 400d, 800d, 1600d. These lengths are achieved by concatenating all context vectors relative to their position with the target word. The training of Cat models across five different data sizes resulted in a total of 20 models.

In contrast, the Sum models set bits identically while the radius was varied at 1, 2, and 4. The dimensionality of the bit-cipher embeddings is equal to the bit-value. The final target words' representations are obtained by element-wise addition of context vectors based on each element's representation index, leading to a blending of context information. Given five distinct data sizes, the inventors trained a total of 60 Sum models.

For comparability across models, the inventors derived word embeddings from the GLoVe 6B embeddings, encompassing 400,000 tokens and with tokens appearing in the evaluation datasets, yielding a total of 419,374 unique word embeddings. Any words identified within the context window that did not exist in the curated word-list were labeled as out-of-vocabulary (OOV) and were consequently assigned a distinctive embedding. This strategy for managing 00V words contributes to memory optimization, given that it mandates the processing of only a particular subset of words.

### 1.2. Probing Experiments

### 1.2.1 Probing Models

The conduction of Probing experiments included designing POS tagging with the Georgetown University Multilayer (GUM) dataset, Named Entity Recognition (NER) using CoNLL-2003 shared benchmark dataset to evaluate the performance of bit-cipher.

Named Entity Recognition. NER probing experiment is conducted by CONLL-2003 shared benchmark dataset which is a collection of data about Reuters newswire articles containing four different entity types: persons (PER), organizations (ORG), locations (LOC) and miscellaneous names (MISC). The probing model for NER is trained on CoNLL-2003 training data using CONLL-2003 validation set for hyperparameter tuning. We follow the simplest and straightforward setup with training an MLP by only using the bit-cipher embedding as the feature and directly adopt labels in the CoNLL-2003 dataset using label-to-index method to convert each label a unique number to setup the input and output of the probing model.

Part-of-speech (POS) tagging. Part-of-speech tagging is a task of assigning labels to each word with its corresponding grammatical category, such as noun, verb, adjective, etc. The Georgetown University Multilayer (GUM) dataset is a richly annotated corpus that contains comprehensive linguistic feature. We extract the POS tagger of words in the GUM and train an MLP following the same setup as the NER experiment with using the bit-cipher embeddings as the input and POS taggers as output.

### 1.2.2 Probing Model Experimental Details

After training the bit-cipher embeddings, the inventors did a two-step post-processing to regularize the representation of words to the final version of the representation and all the probing experiments are conducted using this version of bit-cipher.

First, the whitening transformation was implemented on each collection of vectors used for probing. This is a technique used to remove redundancies and correlations among embedding dimensions, and thereby ensure all word vectors are linearly uncorrelated and have the same variance. It's used in probing to normalize the embeddings by making their distributions more uniform and thus to reduce the bias that may be inherent in the original vectors.

A second pre-processing step applies mean-centering and normalization to each of the vectors. Because bit-cipher vectors are probabilistic, aggregating them as contexts shifts their statistical distributions, which can lead to system instabilities from inconsistencies in magnitudes. The mean-centering and L2 Normalization steps removed common bias and scaled them to unit length to prevent numerical instability, and moreover, ensure that comparisons between word vectors were not affected by arbitrary differences in scale or offset. These appeared to make all vectors more robust and have better generalization capability.

All the probing experiments used a 2-layer Multi-Layer Perception (MLP) for each probing model. The models employed Leaky ReLU activation functions (Xu 2015) to address the vanishing gradient problem, with a dropout rate of 0.5 for regularization. The output layer useuseuses a LogSoftmax function to ensure probability distribution outputs with numerical stability.

### 1.2.3 Results

Probing experiments conducted on 100 separate bit-cipher embedding sets are presented in FIGS. 1.6-1.11 Tables 1.2-1.7. Their results at POS tagging and NER demonstrate noticeable and perhaps expected variations in performance. We see clearly that cipher-only models generally don't improve with increases in data (Tables 1.6 and 1.7), which is sensible given that ciphers only require ranking information and word frequency ranks converge over relatively little data.

For both Sum and Cat models (Tables 1.2-1.4), we see marked improvements from training over increased volumes of data, as observed from FIGS. 1.3 and 1.4 that when the bits are fixed, increasing the data size often results in improved model performance. Furthermore, in the case of Sum models, a clear performance gain is observed with an increase in the value of bits with bits=200 set of models consistently demonstrating the highest performance. However, the performance is likewise sensible, if the quadratic co-frequency information in co-occurrences requires more data to stabilize. However, between the Sum and Cat models, we note that Cat models improve over increases in data with greater stability-they scale more reliably as shown in FIGS. 1.3 and 1.4 that with fixing bits, 8B models always have the best performance. Moreover, we find that Cat models appear to consistently outperform same-dimension Sum models, despite being constrained to fewer bits, as can be seen from the cross-section of comparable models presented in FIG. 1.5, Table 1.1. The inconsistency of model performance tendency is partially due to the fact that the inventors did not do any preprocessing of the data except lowercase when training the bit-cipher. With refined preprocessing, the information gain would be even obviously to observe with the increase of data size.

When similar quantities of data are used, models that are more performant than word2vec, as well as quite comparable to GloVe, can be trained from bit-cipher co-occurrences. This can be see directly in Table 1.1 for 200-dimensional bit-cipher models, which we compare to an externally-trained 300-dimensional word2vec model, a 200-dimensional GloVe and bit-cipher models. On its own, the noised cipher out-competes word2vec, while relatively-low radius (r=4) Sum and Cat models perform comparably to a set of GloVe embeddings, which were also externally trained. Despite the Sum and Cat models both utilizing a substantially smaller radius (r=4) than GloVe (r=10), we see that both of the comparable co-occurrent bit-cipher models out-perform GloVe at POS tagging, and perform comparably at NER. Finally, we note that these results rank the bit-cipher at position 20 amongst the NER models retained on a well-known/public page: Tracking Progress in Natural Language Processing, and moreover, present POS tagging results quite similar to other strong baselines, whose model architectures tend to be much more complex and expressive than the MLPs used in the probing experiments.

### 1.3 Discussion

The detailed comparison between Sum and Cat architectures wouldn't have been possible with a traditional word embedding approach based on gradient descent. Without use of the bit-cipher, the training of 100 distinct models would almost certainly have been outside of the scope of a single work's utilization of GPU resources, especially considering only a handful of the 100 models are likely desirable for use. The gross reduction in computational requirements provided by the bit-cipher allowed us to explore a greater range of model hyperparameterizations, without having to sacrifice scale of data. This has thus opened an avenue for building big data models at low expense, allowing research that explores bespoke models at scale and over wider ranges of hyperparameters and architectural variations.

The inventors anticipate that the training time could be reduced significantly, perhaps by a factor of 100 considering that only 1% of the GPU's computational power is currently used. This reduction could be achieved through improvements in the process by which data is fed to the GPU. Given the simplicity of the training operations in the Sum and Cat models, which require only vector addition of objects that already exist in memory, a massive increase in batching would be required to fully use a GPU.

The Cat model's clear advantage over Sum at consistently producing more performant embeddings from increasing volumes of data, alongside its apparent ability to out-perform GloVe and other embeddings certainly suggested that researchers looking to train their own embeddings could substantially reduce resource requirements without sacrificing performance by using a Cat-based bit-cipher model. However, this doesn't mean that the Sum model should be ignored, and this is especially so when one considers avenues for further architectural improvement. The Cat model is parametrically costly, and it's likely that as more data is used in model training that larger number of bits will be required to resolve tokens effectively. Hence, it is likely that Cat models will ultimately not scale fully, at least when compared with the Sum aggregation architecture. However, the Sum architecture's lack of monotonicity in model improvement with increasing data hints that a weighting, or, attention distribution is needed to effectively aggregate vectors through manipulating weights to different tokens by sum. This would surely be an avenue to explore in future work.

### 1.3.1 Conclusion

The inventors introduced bit-cipher, a method of learning word representations. By using this strategy, we acquire static pre-trained embeddings controlled by dimensionalities set with bits and learn contextual information by simple vector addition, eliminating the need for neural network training. Consequently, the model learns explicit statistical information from large text with strong interpretability. The results show that Cat models consistently outperform Sum models across different dimensions and data sizes, demonstrating greater stability and superior performance even when constrained to fewer bits. However, Sum models also show merit, especially with the potential for further architectural improvements. Furthermore, by comparing with GloVe and word2vec, the competitive performance of bit-cipher is further validated. Overall, the bit-cipher is an efficient and high-performing alternative to traditional pre-trained word embedding methods, with significantly reduced costs, offering a unique niche in the LLM era based on efficiency and interpretability-without a performance compromise.

### 2. Reducing the Need for Backpropagation and Discovering Better Optima With Explicit Optimizations of Neural Networks

Iterative differential approximation methods that rely upon backpropagation have enabled the optimization of neural networks; however, at present, they remain computationally expensive, especially when training models at scale. The inventors propose a computationally efficient alternative for optimizing neural networks that can both reduce the costs of scaling neural networks and provide high-efficiency optimizations for low-resource applications.

2.1 Deriving Explicit Optimization for a Single-Layer Language model

In this section, the inventors present an analysis that show how neural network model parameters can be optimized by algebraic describing the statistics of data. This derivation originally began by analyzing word2vec's CBOW variant Following this, analysis was generalized to a simple single-layer LM, and then, to all feed-forward neural networks with arbitrary non-negative feature sets, as it is now presented.

To define a single-layer model's explicit solution, one must define the data of prediction. This assumes sequential data: a model's objective is to reconstruct a matrix Y∈ {0,1}^{M×N} of unit-normalized rows: |Y_{m,:}|₁=1, which correspond to the set of target elements for prediction in the sequence. The sequence of predictions will be based on M sets of matrix-features, contained in a tensor storing K numerical vector-features of dimension D for each m=1, . . . , M with X∈ [symbol] ^{M×K×D}. In other words, each m-target Y_{m,:} has a corresponding slice from X_{m,:},: ∈ [symbol] ^{K×D} that is a matrix of K vector features, drawn from other rows of Y. Specifically, each m-prediction has each k=1, . . . , K of its features drawn from the previous K rows in Y before the m^{th}: X_{m,k,:}=Y_{im-k,:}, defining the auto-regressive nature of the LM. Here, i∈ {1, . . . , N}^{M} is the vector of target indices for each prediction in the sequence of M, and tokens early in documents—with m<K—are padded with “<pad>”.

The derived statement of optimization is defined for a decoder-matrix: U∈ [symbol] ^{D×N} under the action of the softmax function: φ, defined as: Ŷ_{m,:}=φ(Hₘ, U), where hidden states for each prediction are computed as the sum of vector-features:

$${H}_{m , :} = {Σ}_{k = 1}^{K} {X}_{m , k , :} .$$

Under this notation, the LM is optimized by the cross entropy loss, or, negative log-likelihood of model prediction probabilities:

$$L = - {Σ}_{m = 1}^{M} log {ϕ ( {H}_{m , :} U )}_{{i}_{m}} \qquad EQ . 2.1$$

### 2.2 an Explicit Solution for Single-Layer Optimization

To understand the explicit solution's derivation and potential applications, it is helpful to state:

Definition: A data set of vector-inputs H ∈ R^{M×D} and -outputs Y ∈ R^{M×N} has generalized co-occurrences F(H,Y)∈R^{D×N} between inputs and outputs defined by the sum of outer products:

$$F ( H , Y ) = {Σ}_{m = 1}^{M} {H}_{m , :} ⊗ {Y}_{m , :} = {H}^{T} Y \qquad EQ . 2.2$$

We go on to show that this definition is critical to softmax-activated optimization:

Theorem: A softmax-activated feed-forward layer receiving K-norm non-negative D-dimensional inputs H_{m,:} for each target of prediction Y_{m,:} is approximately optimized by a column-wise translation of the layer's generalized log-co-occurrence matrix: U_{j,i}=log F(H, Y)_{j,i}+wᵢ. The translating weights, wᵢ, are defined by i-column (output) as:

$${w}_{i} = \frac{K - 1}{K} log ( {Σ}_{d = 1}^{D} {F ( H , Y )}_{d , i} ) ,$$

defining an explicit form for each of the layer's j,i-parameters by the expression:

$${U}_{j , i} = log {F ( H , Y )}_{j , i} - \frac{K - 1}{K} log ( {Σ}_{d = 1}^{D} {F ( H , Y )}_{d , i} ) \qquad EQ . 2.3$$

Proof of the above is provided in The Appendix for reference. In general, we'll refer to K as a priming number. In circumstances where features are not unit-normalized (but still positive) the explicit solution also appears to function quite well. However, one must extend the priming number from the discrete number of features to an estimate of this as the average norm of a given feature vector:

$$\hat{K} = ( {Σ}_{m = 1}^{M} {Σ}_{d = 1}^{D} {H}_{m , d} ) / M .$$

However, it turns out that the most critical knowledge required for the explicit solution's use in application is understanding explicit forms for given softmax classifier's inputs and outputs. For a decoder-such as U in the theorem—it is often quite clear what the inputs (features) and outputs (supervising targets) are. While the explicit solution may be applied locally, to individual layers of, multi-layer networks, compositional optimization (not covered in this work) of multi-layer networks require further investigation. Note: compositional, attention-supported networks are covered in the next section.

### 2.3 Computational Experiments

The choice to use data from the BabyLM challenge for language modeling is twofold: as a benchmark, BabyLM provides comparative information against systems submitting to the challenge, while its relatively small size allows for rapid prototype iteration. Interested in the experimental benefits offered by small size, the inventors conduct all BabyLM experiments on its smallest training set of 10-million tokens, and then sample down to 10% of its development data to monitor the possibility of early stopping. All language modeling experiments use Adagrad and a learning rate of η=0.01 to optimize models for 32 epochs (iterations) and use no dimensionality reduction, which is left for future work (discussed below). However, this requires the use of a vocabulary-sized embedding layer, which presents a hard constraint on the feasible vocabulary sizes that may be used in system memory. Thus, the inventors follow and use the byte-pair encoding algorithm for tokenization, limiting the number of merge rules to fix a vocabulary size of 2¹²+2 tokens, reserving the +2 additional slots used for an out-of-vocabulary token and a padding token, the latter of which assures points of prediction are based on exactly r features. Finally, as a demonstration of the feed-forward optimization's generalization over data domains, this section's final sub-section will describe preliminary computational experiments on MNIST, demonstrating the explicit optimization's performance on handwritten digit classification.

### 2.3.1 Language Modeling Experiments

The architecture analyzed in section 2.2 may be augmented in two ways. First, since co-occurrence matrices are sparse, language modeling experiments require a model of noise to fill co-occurrence zeros with small positive values. Second, alongside word2vec's standard sum-based aggregation, the inventors here explore the improvements obtained from radial-concatenation of inputs, which increases parameter complexity and performance, while demonstrating the optimization's capacity for architectural generalization.

### 2.3.1.1 Modeling Noise in Observations

To assure that generalized co-occurrence matrices are dense, we likewise densify vectors using a model of noise. This is done by first computing a vector of token counts

$$f = {Σ}_{m = 1}^{M} {Y}_{m , :} ,$$

and from it, the average (un-noised) basis vector:

$$\overline{e} = ( {Σ}_{n = 1}^{N} {f}_{n} {e}^{( n )} ) / M ,$$

as well as a model: q ∈ (0,1)^{N}, for the portion of occurrences that each n-token's observations are (non-) erroneous. Assuming that the highest-count tokens will be the least erroneously observed, we assume that only one error will be observed relative to each token's observed count, that is: qₙ=fₙ/(fₙ+1). Next and regardless of the token that is observed, we wish to modify its standard basis vector according to the probabilities that any different, j-token, should have been observed, instead, which will take the form of a normalized (|p|₁=1) \ textit {noise} vector: p ∈ (0,1)^{N}, defined to be near-uniform as: p=(1−ē)/|1−ē|₁. To understand p intuitively, we first note that 1-minus each of the average embedding v̅'s (normalized) value is also a probability, which expresses the chance that a given dimension's magnitude is spurious (should not be observed). In application, the value of each embedding in the matrix E∈ ^{N×N}, is finalized by adding noise to rows in an embedding layer:

$${E}_{n , :} = {q}_{n} {E}_{n , :} + ( 1 - {q}_{n} ) p \qquad EQ . 2.4$$

which is used to re-define the inputs-tensor densely: X_{m,k,:}=Eᵢ_{_{m−x}} for each k=1, . . . , K of token m's input feature-vectors.

### 2.3.1.2 Context Models and Generalized Co-Occurrences

To define features for each m^{th} token according to its K previous, noisy/dense embedding-vectors, we consider two conditions (architectural variants). The first considers the sum of vectors from X—mapped into X—from the K previous tokens within the radius of KL

$${H}_{m , :} = {Σ}_{k = 1}^{K} {X}_{m , k , :} .$$

We note once again that tokens early in documents—with m<K—are padded with the “<pad>”. While aggregations defined by sums are indicated by Sum in tables, figures, and experiments; the second variant considered featurizes each m^{th} token according to E-vector concatenation, and so is indicated by Cat in tables, figures, and experiments. Hidden states for Cat models are ultimately expressed quite similarly:

$${H}_{m , :}^{( C a t )} = {[ {X}_{m , k , :} ]}_{k = 1}^{K} .$$

Regardless of featurization, a dense co-occurrence matrix is now concisely expressed by the sum of outer products of standard-basis output vectors with their dense input vectors, i.e., we compute the matrix F(H,Y) for Sum-explicit solutions, and instead compute F(H^{(Cat)},Y) for the Cat-model solutions.

### 2.3.2 Handwritten Digit Classification

For digit classification, MNIST requires determining a label from {0,1,2,3,4,5,6,7,8,9} for a data set of M=60,000 (non-sequentially ordered) images. Thus, we consider each m of MNIST's training instances as having targets within a matrix Y ∈ 0,1^{M×10}, whose rows are unit-normalized: |Y_{m,:}|₁=1. The input images, themselves, are contained in a 28×28-slice of an input matrix X ∈ R^{M×28×28}. MNIST images are numerically structured as 28×28 matrices of integer values that range over 0, . . . , 255. To pre-process MNIST data, we translate all values by (add) 1 to ensure positivity, as well as normalize (divide) each integer by 256 to assure all input-values fall within the range (0,1]; these are then flattened to define feature vectors in the matrix H∈ (0,1]^{M×784} according to the equation:

$${H}_{m , :} = flatten ( ( {X}_{m , : , :} + 1 ) / 256 ) \qquad EQ . 2.5$$

The standard train-test split is then processed, using the derived optimization presented in above. Much as we do for LM'ing experiments, we likewise present the results of backpropagation-based iterative optimization on MNIST models, following our application of their explicit solutions. This includes our preliminary investigation into multi-layer models, which uses the derived explicit solution locally by layer (see below). However, to proceed with any of these experiments more consideration is needed regarding MNIST's pre-processing, e.g., since H_{m,:}-input vectors don't all have the same norm.

### 2.3.2.1 MNIST Model Priming

Without an available analytical definition of K for the MNIST model's architecture, we determined to scan priming numbers and compare model accuracy. We generally hypothesize that the MNIST model's priming number is related to the norms of input vectors: Hₘ . . . . This was conducted over the integer range of k∈ {1, . . . , 784}, whose upper limit is the flattened dimensionality—and maximum norm of—of a pre-processed MNIST training instance (784). With these values of k, the priming numbers our scan covered defined normalization weights as:

$$k ↦ {f}_{i}^{- ( k - 1 ) / k} ,$$

which generalized our interpret of the single-layer LM's normalization being a function of the radius:

$$K ↦ {f}_{i}^{- ( K - 1 ) / K} ,$$

which in that scenario is both the number of features per prediction and the 1-norm of each given feature vector.

### 2.3.3 Local Applications of the Explicit Solution to Multi-Layer Networks

To extend the explicit solution to multi-layer networks we take a naïve first approach. This is for both simplicity and the method's potential utility, leaving detailed investigations into multi-layer warm-starts and compositional optimization for future work. The explicit solution is specifically known for softmax-based activation, and thus, one shouldn't expect to find explicit solution values perform well when activation functions are changed. Likewise, since this work does not consider dimensionality reduction, our current options are limited to the input and output dimensionalities, which can't create useful bottlenecks, which are likely need for truly enhanced multi-layer prediction. Nevertheless, one can naïvely 1) train a single-layer classifier, U, and then 2) define second-order hidden states: H⁽²⁾∈ R^{M×N} by first-layer outputs:

$${H}_{m , :}^{( 2 )} = φ ( {H}_{m , :} U ) ,$$

and 3) subsequently define a second layer's decoder by applying the explicit solution over the co-occurrence matrix: F(H⁽²⁾,Y) [symbol] U⁽²⁾∈ R^{N×N}. This procedure is used to train all 2-layer warm-start models, which are applied to MNIST experiments (only). While we consider if this local optimization strategy using the explicit solution could be fully developed into a generalized multi-layer warm start, we ultimately leave these questions to future work, since full functionality in multi-layer warm-starts requires dimensionality reduction and more understanding in activation function processes.

### 2.3.3 Experimental Results

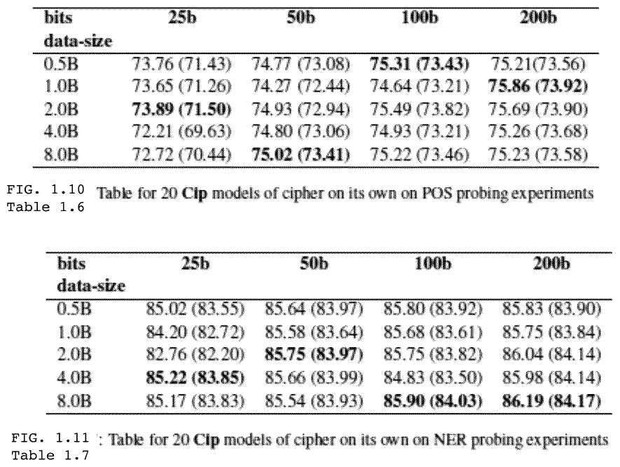

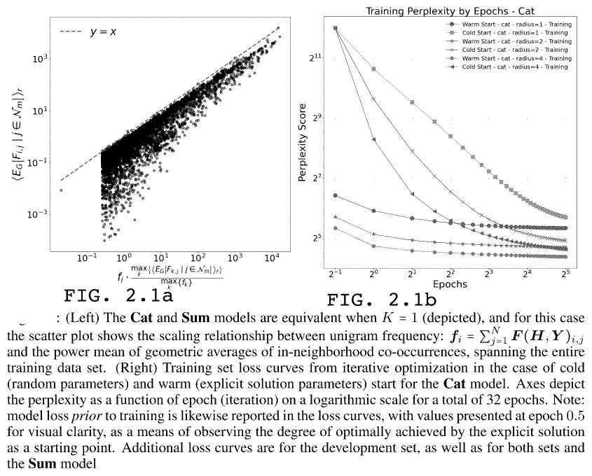

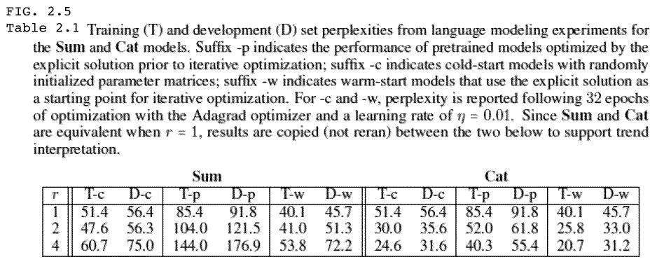

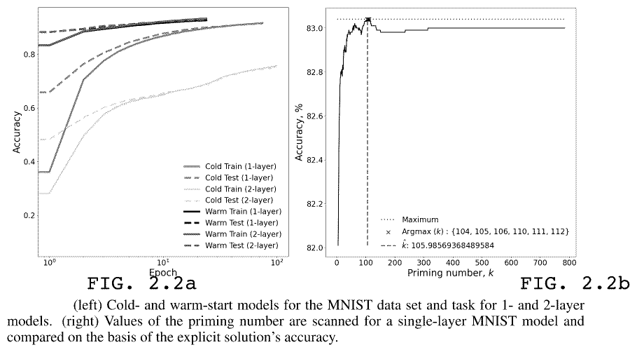

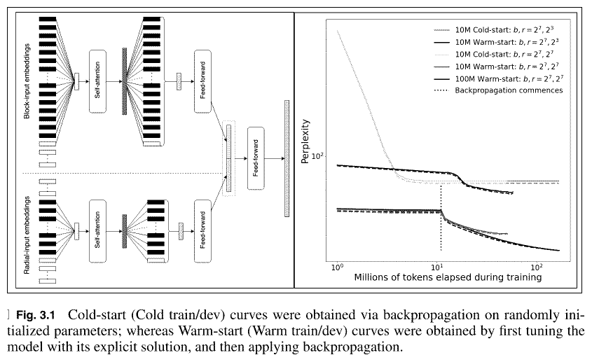

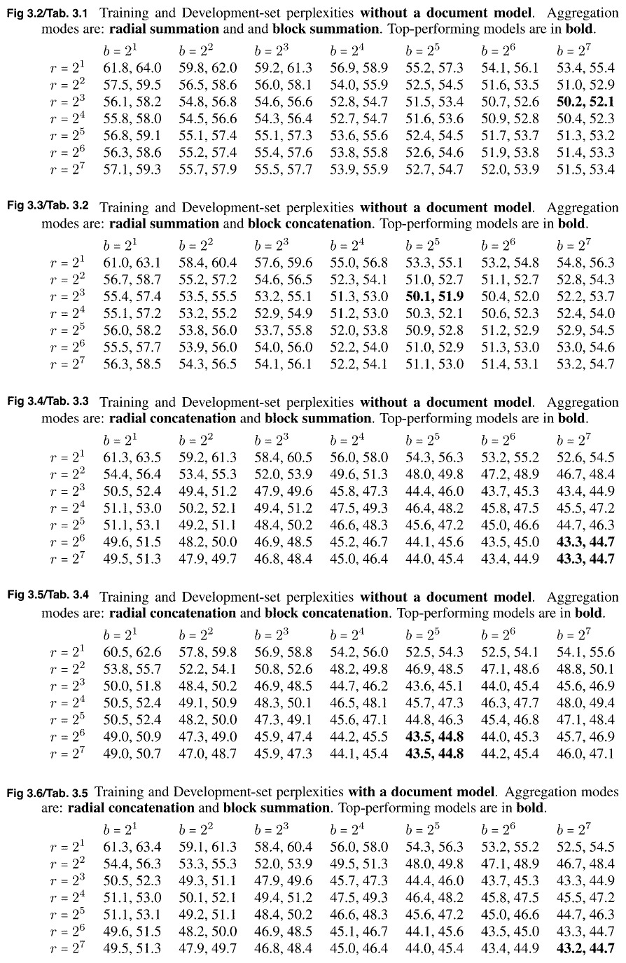

In all MNIST experiment pre-processing, images were flattened, added to 1, and divided by 256, which results in the training set's average norm being approximately 105.99. We can immediately see from the priming number scan (at right in FIG. 2.2 that the initial argmax value for a priming-number is the average norm. Using the average norm, the explicit solution demonstrates non-trivial MNIST classification, achieving 82.86% test set accuracy. At left in FIG. 2.2, the single-layer MNIST cold-start required roughly 5 epochs of learning to reach the explicit solution's starting accuracy of roughly 82%, while the 2-layer (see above) cold-start suffered from parameter disorientation that ultimately left it performing poorly. Warm-starts, however, begin iterative optimization at 2-4-times higher accuracy, and terminates early according to a naïve early-stopping criterion (increased value of cross-entropy loss) sooner. This property is observed for both 1- and 2-layer models, i.e., demonstrating no loss of performance for including a second layer when the warm-start is used. While the single-layer warm-start's early stopping resulted in roughly 4-times less computation, requiring only 23 vs. 93 epochs of training for optimization, the two-layer cold-start never stopped. In both 1- and 2-layer cases, warm-starts led to the highest accuracies: 92.57% for the 1-layer warm-start, and 92.93% for the 2-layer warm start. These values ultimately compared to 91.68% for the 1-layer and 75.64% for the 2-layer cold-start.

Language modeling experiments are discussed in terms of average perplexity: e^{L}/M for both of the Sum and Cat model variants, which again, are equivalent when K=1. Their hyperparametric articulations are recorded both in TAB. 2.1 and in FIG. 2.1 this includes the scenario of models that are pre-trained by the explicit solution prior to any iterative optimization (suffix-p in TAB 2.1; cold-start models, whose parameter matrices are randomly initialized (suffix-c); and warm-start models that use the explicit solution as a starting point for subsequent iterative optimization (suffix-w). At a high-level, we note that Cat-based models generally achieve lower perplexity (better performance) than their Sum-based counterparts, and that explicit solutions initialized the best models, i.e., that models could be improved beyond the point of explicit solution initialization.

Deriving the w-weights that optimize the FF-model's solution required assuming that a scaling relationship exists between an average of co-occurrence averages and token counts. The empirical reality of this apparent—but-noisy relationship is depicted by the cone-shaped linearity in the left panel of FIG. 2.1 for both/either of the Cat and Sum models, which are equivalent when K=1. When this same figure was depicted for larger-radius sum values (e.g., K=2 and 4) in early testing, the scaling relationship was noted diverge somewhat more; this notably appeared to correspond with decreases in performance (increases in model perplexity) observed at larger radii in TAB. 2.1, where perplexity values are stored. However, we note that when poorer-quality scaling relationships of the kind depicted in FIG. 2.1 are observed (for larger radii), it doesn't appear to invalidate the explicit solution gravely, that is, the explicit solution still greatly improves performance over a cold-start. Nevertheless, ramping up to full runs on BabyLM's 10-million token training sample during this work's development made it clear that the scaling relationship likely stabilizes with bigger data. This is a subject that could be interesting to follow up on in future studies. Finally, while the scaling relationship appears to stabilize as data is increased, FIG. 2.1 also guides our future, more refined analysis into the scaling relationship, as the slope of the scaling relationship is likely a small amount shallower than the line y=x in FIG. 2.1. Put differently, refining the analysis of this relationship to better reflect the empirical scaling relationship would likely lead to an improved explicit solution, which could be a promising avenue for future study.

In TAB 2.1, training and development set losses can clearly be seen to co-optimize, with larger percent gaps between training and development loss appearing for larger context windows indicating insufficient generalization, and perhaps the need for more training data when more features are used (larger r-radius). Moreover, related effects can be observed when comparing the Sum and Cat models with increasing radius. Almost paradoxically, perplexity increases for the Sum model at larger radii, while it progressively decreases for the Cat model as larger radii (more features) are used. The pattern of loss-increase with radius can be seen throughout nearly all of the Sum experiments—except the cold-start at k=2—demonstrating the likely need for attention-upon-aggregation when vectors are summed across position, in-line with the transformer-architectural developments, presenting an architectural avenue of study for future work in reducing Sum-based architecture perplexities through integration and analysis of attentive mechanisms. Furthermore, we note that the cold-start model performing ‘best’ at k=2 is likely a sign of less-stable optimization, particularly, since cold-starts are randomly initialized. This remark is parallel to our observation throughout testing that explicit solutions demonstrate monotonic performance scaling, i.e., perplexity exclusively increases or decreases as hyperparameters are increased. This observations is an indication of a strong ablation advantage provided by the explicit solution - - - not only for its efficiency at producing comparable models and evaluations, but moreover, for the deterministic consistency that its provides. Juxtapose this to the erratic ablataion properties exhibited by the randomly-initialized models, i.e, whose Sum models have lowest at a bounded value: K=2. This likely spurious result may have emerged from one ‘lucky’ initialization in the table's 6 cold-start models. Comparatively, our experimentation with the explicit solution leading up to the Sum-Cat experiments left zero doubt by demonstrating so much consistency Sum models performing worse with increased radius. Without the explicit solution, this could well have misguided our investigation, e.g., away from considering Cat-based models, and would have left us only with the option to ‘waste’ computation on redundant experiments averaging performance from different random initializations at much larger expense.

Models on the Cat-side of TAB. 2.1's experiments more-intuitively drop in perplexity as as the radius is increased, and demonstrate the diminishing returns gained from increased positional information, i.e., indicating that most predictive information is present close to the point of prediction. The smooth reduction in perplexity-juxtaposed to increases seen for Sum models—indicates the utility of the outer product as a lossless (sparse) featurization pre-processor for the integration of independently-measured features; that is, since the concatenation of input vectors interacts with the outer product of token type and position, independently (this is also why Cat models have K-times the parameters of their Sum counterparts). In the right panel of FIG. 2.1, training loss by epoch is presented for Cat models. Here, the impact of a warm start can be seen on a logarithmic scale, where over the 32 iterations provided for optimization, cold-start models ended not far from where warm-starts began. For small experiments like these, the efficiency benefit is essentially a 50% reduction of training cost; however, for larger/more-parametrically complex models trained over larger quantities of data, this reduction may well magnify.

### 2.4 Discussion

Our optimization of models that have been warmed-up by the explicit solution is equivalent to the general case of 1) assuming (freezing) a matrix model (of co-occurrences) and then 2) determining a best intercept for a feed-forward architecture. This separate-intercept implementation was actually the initial (equivalent) formulation used for MNIST experiments, and both implementations are provided as software with this paper's release. The relative ease of using the MNIST data set to train a predictive model on an entirely different-numerical vectors vs, categorical text-data domain underscores the potential breadth of application of which the explicit solution is capable. Thus, an additional reason for performing MNIST's experiments (and providing their software) using a different implementation is to present the explicit solution in the context of a general featurizer, which could potentially be modified, e.g., to use a convolutional processing in the future. In fact, the sliding window technically does this for language modeling over one dimension, using a padded and uniform 1-dimensional convolution. We likewise present the explicit solution as a local optimizer, demonstrating have warm starts can naïvely be applied to individual layers of parameters, from the bottom of a given network. Thus, to produce more complex deep network architectures one can apply the explicit solution, from the bottom up first, to optimize a network non-iteratively/locally, and then subsequently-compositionally-apply backpropagation. However, our approach does not change the downstream objective (it is still a softmax), allowing subsequent iterative optimization to be conducted to great effect, on top of warm starts. This multi-layer process is efficient, since the explicit solution's optimization requires information transmission in only the forward direction; that is, it requires only a single pass over the data for an accumulation of potentiation by its vector-statistics, even when applied to multi-layer networks

It is possible to assume pretrained vectors from other algorithms for a fixed vocabulary; however, this assumption is challenged by the explicit solution's need for positive-valued features. In particular, low-dimensional token vectors obtained from GloVe, GPT-2, etc. will produce components with negative values. Co-occurrences with the target one-hots and these negative values will thus result in partially negative-valued co-occurrence matrices, and the explicit solution should be proportional to the logarithm of these matrices. While the domain of the logarithm can be extended to negative numbers via the complex number system, this would result in the need to formalize softmax prediction as a function of the complex domain. Assuming U and H are taken over the complex field C, one need only compute φφ* (Hₘ,; U), too, since φφ′, or, the vector-output of textit {magnitudes} of the values returned by the softmax function (complex conjugate products) is a probability distribution. This would undeniably present an underlying quantum nature—and perhaps expressive benefits to prediction—which could well be considered.

### 2.4.1 Conclusion

The inventors introduced an explicit optimization method for single-layer feed-forward neural networks, which moreover, demonstrated significant promise for generalized extension into multi-layer networks. The inventor's method, underpinned by insights from mathematical analyses, demonstrates near-optimal performance, with iterative optimization offering only finer enhancements, and randomly initialized parameters gradually converging towards the performance levels of explicit solutions. This includes for iterative applications of explicit solution local optimizations in multi-layer networks. The inventors see their work as serving as a keystone, enhancing training efficiency and model interpretability, while providing insight into model function. The efficacy of our solution is substantiated through language modeling and digit classification tasks, underscoring its wide-ranging applicability and generalization potential. The inventors anticipate that this work will catalyze further research into the application of explicit optimization methods to more intricate, compositional multi-layer architectures and attention-based models, enriching the field with new perspectives and methods.

### 2.5 Appendix/Supplementary Material

### 2.5.1 Derivation of the Single-Layer Model's Explicit Solution

Theorem: A softmax-activated feed-forward layer receiving K-norm non-negative D-dimensional inputs H_{m,:} for each target of prediction Y_{m,:} is approximately optimized by a column-wise translation of the layer's generalized log-co-occurrence matrix: U_{j,i}=log F(H, Y)_{j,i}+Wᵢ. The translating weights, wᵢ, are defined by i-column (output) as:

$${w}_{i} = \frac{K - 1}{K} log ( {\sum }_{d = 1}^{D} {F ( H , Y )}_{d , i} ) ,$$

defining an explicit form for each of the layer's j,i-parameters by the expression:

$${U}_{j , i} = log F {( H , Y )}_{j , i} - \frac{K - 1}{K} log ( {\sum }_{d = 1}^{D} {F ( H , Y )}_{d , i} ) \qquad EQ 2.6$$

Proof: Abbreviating F(H, Y) by simply F for concise notation, first re-arrange the starting expression for a j,i-index pair of U is:

$${U}_{j , i} = log {w}_{i} {F}_{j , i} \qquad EQ . 2.8$$

It is a matter of algebra to reduce the likelihood function's general form with w to an expression only dependent on w's components in the denominator-factors:

$${e}^{L} = {\prod }_{m = 1}^{M} \frac{{e}^{{H}_{m , : {U}_{: , {i}_{m}}}}}{{\sum }_{n = 1}^{N} {e}^{{H}_{m , : {U}_{: , n}}}} = {\prod }_{m = 1}^{M} \frac{{\prod }_{d = 1}^{D} {F}_{d , {i}_{m}}^{{H}_{m , d}}}{{w}_{{i}_{m}}^{- K} {\sum }_{n = 1}^{N} {w}_{n}^{K} {\prod }_{d = 1}^{D} {F}_{d , n}^{{H}_{m , d}}} \qquad EQ . 2.9$$

Above, the expression shows that one need only minimize the denominator at right to maximize the overall expression, i.e., optimize the likelihood. Since the logarithm is a monotone function, this is likewise equivalent to maximizing the logarithm of the denominator, which we denote by [symbol] :

$$ϒ = {\sum }_{m = 1}^{M} {ϵ}_{m} = {\sum }_{m = 1}^{M} log [ {w}_{{i}_{m}}^{- K} {\sum }_{n = 1}^{N} {w}_{n}^{K} {\prod }_{d = 1}^{D} {F}_{d , n}^{{H}_{m , d}} ] \qquad EQ . 2.1$$

We then proceed directly, by differentially optimizing Y and compute partial derivatives of ϵₘ:

$$\frac{\partial {ϵ}_{m}}{\partial {w}_{i}} {\vert}_{{i}_{m} = i} = - \frac{{Kw}_{i}^{K - 1} {\prod }_{d = 1}^{D} {F}_{d , i}^{{H}_{m , d}}}{{\sum }_{n = 1}^{N} {w}_{n}^{K} {\prod }_{d = 1}^{D} {F}_{d , n}^{{H}_{m , d}}} - \frac{K}{{w}_{i}} ; \qquad EQ . 2.11$$

$$\frac{\partial {ϵ}_{m}}{\partial {w}_{i}} {\vert}_{{i}_{m} = i} = - \frac{{Kw}_{i}^{K - 1} {\prod }_{d = 1}^{D} {F}_{d , i}^{{H}_{m , d}}}{{\sum }_{n = 1}^{N} {w}_{n} {\prod }_{d = 1}^{D} {F}_{d , n}^{{H}_{m , d}}}$$

Putting these pieces together in-sum produces the expression:

$$\frac{\partial ϒ}{\partial {w}_{i}} = - \frac{{Kf}_{i}}{{w}_{i}} + {\sum }_{m = 1}^{M} \frac{{Kw}_{i}^{K - 1} {\prod }_{d = 1}^{D} {F}_{d , i}^{{H}_{m , d}}}{{\sum }_{n = 1}^{N} {w}_{n} {\prod }_{d = 1}^{D} {F}_{d , n}^{{H}_{m , d}}} \qquad EQ . 2.12$$

it becomes helpful now to identify a weighted, geometric mean of co-occurrences with token i over the m^{th} instance's features:

$${E}_{G} [ {F}_{j , i} \vert {H}_{m , :} ] = {( {\prod }_{d = 1}^{D} {F}_{d , i}^{{H}_{m , d}} )}^{1 / K} .$$

Provided their inner product with the weights is approximately a constant c∈ R:

$${\sum }_{n = 1}^{N} {w}_{n} {E}_{G} [ {F}_{j , n} \vert {H}_{m , :} ] \approx c . \qquad EQ . 2.13$$

solving for

$$\frac{\partial ϒ}{\partial {w}_{i}} = 0$$

results in the following proportionality for each token-index, i:

$$\frac{{f}_{i}}{{w}_{i}^{K}} = {\sum }_{m = 1}^{M} \frac{{{𝔼}_{G} [ {F}_{j , i} \vert {H}_{m , :} ]}^{K}}{{\sum }_{n = 1}^{N} {w}_{n} {{𝔼}_{G} [ {F}_{j , n} \vert {H}_{m , :} ]}^{K}} ∝ {\sum }_{m = 1}^{M} {{𝔼}_{G} [ {F}_{j , i} \vert {H}_{m , :} ]}^{K} \qquad EQ . 2.14$$

Each E_{G}[F_{j,i}|H_{m,:}] likely correlates to fᵢ, and their sum further integrates a broader average:

$${\sum }_{m = 1}^{M} {{E}_{G} [ {F}_{j , i} \vert {H}_{m} \text{,:} ]}^{K} = M {〈 {E}_{G} [ {F}_{j , i} \vert {H}_{m} \text{,:} ] 〉}^{K} \qquad EQ . 2.15$$

Here, the expression [symbol] E_G[F_{j,i}|H_{m,:}] [symbol] indicates the K-power mean of the geometric means of co-occurrences with token i. We thus find that an explicit form for wᵢ's proportionality is:

$${w}_{i} ∝ \frac{{f}_{i}^{1 / K}}{〈 {E}_{G} [ {F}_{j , i} \vert {H}_{m , :} ] 〉} ∝ {f}_{i}^{\frac{1 - K}{K}} = {( {\sum }_{d = 1}^{D} {F ( H , Y )}_{d , i} )}^{\frac{1 - K}{K}} \qquad EQ . 216$$

dependent on the double-averaged denominators scaling with count: [symbol] E_{G}[F_{j,i}|H_{m,:}] [symbol] ∝fᵢ. ▪

3. Explicit Foundation Model Optimization with Self-Attentive Feed-Forward Neural Units

In this section, the inventors train highly-specified and complex multi-layer neural architectures that they refer to descriptively as self-attentive feed-forward unit (SAFFU) layers. These are then applies to the development of a hyper-efficient transformer, which appears to generalize well over small-cognitively-feasible-volumes of data. Results from testing demonstrate explicit solutions for SAFFUs grossly outperform counterparts optimized by backpropagation alone. Moreover, further application of backpropagation after explicit solutions leads to the discovery of better optima from smaller scales of data, i.e., that training highly-performant models from much smaller scales of data is enabled by warm starting models with their explicit solutions.

### 3.1 Introduction

The cost of training LLMs becomes extremely expensive when models become large in part due to large parameter requirements, but perhaps most of all from the tremendous scales of data required-LMs commonly require volumes of language that far exceed what a human would experience in a lifetime. Naturally, two concerns confront the inventors: 1) training LLMs more efficiently, with respect to training times and computational costs; and 2) obtaining LLM-like abilities from smaller quantities of data, i.e., from at most what a human might experience. The inventors show how explicit solutions to parameter optimization-which use assumptions over architectures to mathematically deduce algebraic forms for the parameters in neural network weight matrices without backpropagation-make significant headway in satisfying concerns 1 & 2. Once an explicit solution is mathematically derived for a neural network, “plug and chug” computations can be leveraged to great efficiency to produce more-performant and—generalized models, using very little data.

In this section, the inventors extend knowledge of explicit solutions from single-layer feed-forward neural networks, to an architecture with compositionally-linked feed-forward and self-attention layers. Their work demonstrates an explicit optimization technique that significantly accelerates model training processes, reaching optima far beyond the reach of backpropagation, alone. So when this solution is applied to self-attention networks, it accelerates time-to-optimization and finds vastly better optima with better generalization qualities, offering a vital alternative to the current trends in neural network training.

By conducting ablation experiments over a large number of LM architectural variants, the inventors show that “warming up” (warm-start) models with the explicit solution for self-attention leads to better generalization, more rapidly. This discovery is largely invariant to the scales of training data used, i.e., warm-starts lead to objectively better models on both large and small data sets. Furthermore, these findings indicate that iterative optimization with backpropagation only leads to generalized models with the explicit solution-models initialized randomly at least appear to require more computation than any conducted experiments, regardless of scale. The inventors conjecture that model disorientation, in fact, leads to randomly-initialized models not achieving their full potential (regardless of size), and discuss this effect in relation to how LLMs might be overcoming disorientation in applications.

useuse

### 3.2 SAFFU Layer Architecture

As discussed in Sec. 2, this derivation began by analyzing word2vec's CBOW variant, and was generalized to simple single-layer LMs, and then all feed-forward neural networks with arbitrary non-negative feature sets, as it is presented in Appendix 2.5. Derived model-parameters are generally based on co-occurrences, requiring some re-normalization and non-linear transformation to approximate points of loss minimization. The discovery of the priming number—a constant dependent that allows conversion of input-output co-occurrence into well-optimized neural models—should not be understated, e.g., allowing extension of explicit solution applications from text (categorical) to image (numerical) input. Beyond extending explicit solutions to other data types, discovering the priming number hinted at the possibility of complex and multi-layer solutions. The inventors work now picks up from that point, stacking multiple single-layer warm-starts to form multi-layer architectures, and further, investigates compositionally-bound layers and an encoder-decoder architecture combining self-attention and feed-forward layers wrapped in a generalized neural unit.

### 3.2.1 Self-Attentive Feed-Forward Neural Units (SAFFUS)

The inventors again first define the data on which SAFFUs now will operate, assuming sequential instances: a model's objective is to reconstruct a matrix Y ∈ {0,1}^{M×N} of unit-normalized rows: |Y_{m,:}|₁=1 corresponding to target elements for prediction. Predictions are based on M sets of matrix-features contained in a tensor storing K vectors of dimension D for each m=1, . . . , M: X∈ R^{M×K×D}. Thus, each m-target: Y_{m,:} has a slice from X_{m,:},: ∈ R^{K×D} that is a matrix of K vectors, drawn from other rows of Y. LMs are auto-regressive, so each m-prediction has every k=1, . . . , K of its features drawn from an i-row of Y:X_{m,k,:}=Y_{i,:}, or some low-dimensional embedding matrix: E∈ R^{N×D}; D<N.

Standard self-attention layers have a layer-specific dimension: D_{A} and three parameter matrices: W_{q}, Wₖ, Wᵥ∈ R^{D×DA}; used together with the vector-valued softmax activation function: φ(x)ᵢ=e^{xi}/Σⱼe^{xj}. Attention distributions: A∈ R^{N×K} are applied for all M predictions:

$$A = φ ( {X}_{m , : , :} {W}_{q} {W}_{k}^{T} {X}_{m , : , :}^{T} )$$

to weight vectors for each m, producing hidden states: H=AX_{m,:},: and score vectors: HWᵥ, the latter of which are passed through application-specific activation functions, such as the rectified linear unit (ReLU).

The inventors first propose eliminating D_{A}. This is accomplished easily within φ, since the product

$$W = {W}_{q} {W}_{W}^{T} ∈ {R}^{D \times D}$$

is equivalent w its component-wise formulation:

$$A = φ ( {X}_{m , : , :} {WX}_{m , : , :}^{T} ) .$$

This forces the re-consideration of Wᵥ's use of D_{A}, which could instead be thought of as a hidden or decoder dimension, provided one defines D_{A}=N. We notate decoders by U∈ R^{D×N}, making the pre-activation form for a two-layer self-attention plus decoder model easily expressible as:

$$φ ( {X}_{m , : , :} {WX}_{m , : , :}^{T} ) {X}_{m , : , :} U .$$

This standard matrix expression obfuscates the softmax function's input-output structure, but the attention layer operates by-query, i.e., φ normalizes by row. If queries are defined by h^{th} features, score vectors can be expressed individually as:

$$φ ( {X}_{m , h , :} {WX}_{m , : , :}^{T} ) {x}_{m , : , :} U .$$

We next ask if quadratic form for A_{m,:} be computed in a way separating X from W, exchanging the order of self-attention's multiplication to:

$${A}_{m , :} = φ ( {X}_{m , h , :} {X}_{m , : , :}^{T} W ) .$$

Note that this formulation requires redefining the dimensionality of W∈ R^{K×K}. To concisely notate, we store consolidated quadratic features for each target in Q∈ R^{M×K}, defined by-m as

$${Q}_{m , :} = {X}_{m , h , :} {X}_{m , : , :}^{T} ∈ {R}^{K} ,$$

which refines the hidden-state equation to: H_{m,:}=φ(Q_{m,:}W) X_{m,:,:}. Finally, we propose a negative logarithm operate on attention-outputs: A_{m,:}=−log φ(Q_{m,:}W). While the softmax operates on score vectors: φ(A_{i,:}X_{m,:,:}U), attention's log-softmax mathematically ‘activates’ features by providing separation in differential structure between attention and decoder layers that makes a solution tractable. Queries from the layer's head h—a hyperparameter—are used to compute outputs:

$$SAFFU ( {X}_{m , : , :} ) = φ ( - [ log φ ( {X}_{m , h , :} {X}_{m , : , :}^{T} W ) ] {X}_{m , : , :} U ) \qquad EQ 3.1$$

### 3.2.2 Extending Explicit Solutions to SAFFU Layers

Motivation for log-probability activation becomes clearer when the explicit solution proofs are considered in Appendices 2.5 & 3.7, where logits can be seen to partly invert softmax operations. As in the proof of the explicit solution in Appendix 2.5, this section refers to K as a priming number, and as was noted throughout Sec. 2 this section relies upon circumstances where features are not unit-normalized (but still positive), where the explicit solution appears to still function quite well. This extension of the priming number from discrete feature sets is provided by utilizing the average norm of a given feature vector:

$$\hat{K} = ( {\sum }_{m = 1}^{M} {\sum }_{d = 1}^{D} {H}_{m , d} ) / M ,$$

which is shown effective in testing. However, the knowledge for explicit solution use is understanding layer inputs and targets. Decoders—such as U in the theorem—often have clear inputs (features) and outputs (supervising targets); however, compositional layers like W—within a SAFFU's ‘deep’ attention layer—require investigation to determine an answer to: “what supervises self-attention?”

The explicit solution to single layers tells in part that: first-order approximations can be computed locally from generalized log-co-occurrences matrices, from the bottom up. However, these kinds of local/first-order approximations are non-compositional, that is, even when they are applied to multi-layer softmax networks, their local optimization will is of lower quality than what's achievable by backpropagation, which uses the differential structure of function composition to tease higher-order behavior out of networks. The inventors emphasize this, specifically, to highlight that the SAFFU's explicit solution is the first such compositional explicit solution. Regardless, the task is to train an LM by minimizing the cross entropy of SAFFU layers over W and U:

$$L = - {\sum }_{m = 1}^{M} log {SAFFU ( {X}_{m , : , :} )}_{{i}_{m}} \qquad EQ . 3.2$$

where i∈ {1, . . . , N} M is the vector of target indices for each prediction in the sequence of M.

use

### 3.2.2.1 Optimizing a SAFFU's Decoder Layer

Supposing one already possessed an optimized attention layer W, our notational conventions for the M attention distributions: A_{m,:}=−log φ(WX_{m,h,:}X_{m,:,:}) and their corresponding hidden states: H_{m,:}=A_{m,:}X_{m,:,:} make direct application of EQ. 2.3 straightforward with knowledge of U's priming number: K_{U}. The negative logarithm in A's definition is not unit-normalized, but an upper bound on its values—the negative logarithm of a probability distribution, i.e., entropy—is easily obtained from a uniform distribution: K_{U}=Klog K, recording the layer aggregation of K unit-normalized features using K entropically-activated probabilities as feature weights. With K_{U}, one can fully apply EQ. 2.3 over H and Y to state U's explicit form:

$${U}_{j , i} = log {F ( H , Y )}_{j , i} - \frac{{K}_{U} - 1}{{K}_{U}} log ( {\sum }_{d = 1}^{D} {F ( H , Y )}_{d , i} ) \qquad EQ . 3.3$$

Note that computing F(H,Y) requires W being known form first: H_{m,:}=−log φ(Q_{m,:}W) X_{m,:,:}, i.e., U's explicit solution can only be computed from W.

### 3.2.2.2 Optimizing a SAFFU's Attention Layer

Appendix 3.1 presents finer details on the derivation the SAFFU's explicit solution. This solution also relies on direct application of EQ 2.3, and requires answering the question: “what supervises self-attention?” One can think of self-attention as producing feature-weighting distributions, and perhaps could anticipate that supervising information for a self-attention distribution is 1) dependent on its decoder, and 2) guides weights to features that are most predictive of targets. Ultimately, solving L's derivatives with respect to W_{i,j} set equal to 0 lead us to the revelation that V∈ R^{M×K} defined by V_{m,k}=[U_{:,i}_{ₘ}−Uφ(H_{m,:} U)]˜·X_{m,k,:} was “supervising” W, i.e., as an analog to Y (see Appendix 3.1.2). While we intentionally consolidated the attention layer's inputs under the form Q it was a marvel-whether by serendipity or the need for concise notation—that the matrix V emerged. In it contains variational information about the decoder matrix U, which summarizes what the attention-matrix W should expect from U's reactions to its (W's) activations.

By comparing the co-optimal criteria of U and W in EQs. 3.6 and 3.10, we were able to state concretely that the input-output pair of matrices Q and V are to W, as the pair H and Y are to U in Appendix 3.1.2. However, there are some differences to note between EQs. 3.6 and 3.10. In particular, while the decoder's softmax only engages one output dimension at a time in its derivative via Y_{m,i} in EQs. 3.5-3.6, the attention layer's softmax has a derivative that engages all of its output dimensions simultaneously via

$${\sum }_{k = 1}^{K} {V}_{m , k}$$

in EQs. 3.9-3.10. Regardless, the matrix V represents the “internal” targets of the SAFFU—supervising W to temper its features to the decoder's variation—leaving W's priming number K_{w} as the only remaining unknown in its explicit solution:

$${W}_{j , i} = log {F ( Q , V )}_{j , i} - \frac{{K}_{W} - 1}{{K}_{W}} log ( {\sum }_{k = 1}^{K} {F ( Q , V )}_{k , i} ) \qquad EQ . 3.4$$

While estimating a ‘good’ value of Ku depended on the input data in X and the functional form of the layer defined by W, W's priming number, itself, depends only on its input features in Q. Consolidated quadratic features in Q are defined as Q_{m,:}=X_{m,h.:}X_{m,:,:}∈ R^{K}, where each vector Q_{m,:} contains K inner products of the vector inputs from X_{m,:,:}∈ R^{K×D} with their head-feature h. These are inner products between unit-normalized vectors, so their values Q_{m,:} can be thought of as similarities between the head feature and the others in X_{m,:,:}. Thus, while Q's values are each less than one, one should expect |Q_{m,:}|₁>1. However, the norms of vectors in Q are bounded: |Q_{m,:}|₁∈ [0, K], since each ‘similarity’ cannot have value greater than 1. Thus, a sub-linear, increasing function of K is likely useful for estimation of W's priming number, and, we set K_{w} at: K_{w}=log K for simplicity. Note: Setting K_{w}=log K immediately improved performance over the value K_{w}=K in early testing. Regardless, it's likely the case that for K_{w} (and K_{U}) can be refined further by setting their values to the average norms of their input vectors. Finally, since computing F(Q,V) requires knowledge of U (V's expression depends on U), we note that independently having some initial solution to either U or W before the other is an essential pre-requisite for efficient and stable computation.

### 3.2.3 Initializing SAFFUs

The co-dependence between the explicit solutions for W and U is a start-up problem, where one needs only a guess to get the process going. This could be a ‘dumb’ guess, like a uniform, e.g., all-1 initialization for W, or it could be more nuanced and estimate W (or U), and perhaps alternatingly update their values until a stopping criterion is reached. For a non-uniform initial guess at W, one must consider the input data's distributional structure. The vectors contained within X will generally be word embeddings, and we require only that word embeddings are non-negative and unit-normalized. Standard word embeddings can be coerced to this domain via a variety of methods, e.g., by passing traditional vectors through a softmax function. Regardless, we denote embedding layers by E∈ (0,1]^{N×D}, and assume that each i-token's embedding vector (from the vocabulary of N) has a unit 1-norm: |E_{i,:}|₁=1. Furthermore, embedding layers with the same hidden dimension as the decoder layer (D) can be transformed similarly to V to grossly improve initialization of W over uniform values:

$$= [ log {E}_{{i}_{m} , :} - log {E}^{T} {\sum }_{j = 1}^{M} \frac{{Y}_{j , :}}{M} ] {X}_{m , k , :}^{T} .$$

All testing with SAFFUs has demonstrated this initialization grossly-outperforms uniform starts, and accelerates optimization. Finally, note first that both of EQ. 3.3 and 3.4 rely upon a logarithm of their generalized co-occurrence matrices. The explicit solution's expression for Uji in EQ. 3.3 has both targets and features which are by-definition positive-valued; however, the V-\ textit {targets} for the attention-matrix solution in EQ. 3.4 will likely contain negative values, and subsequently, have the potential to introduce negatives into F (QV). While the logarithm can be extended from (0, ∞) to C \ {0}, the explicit solution only applies to positive-valued co-occurrences. As in Sec. 3.2, we note: negative inputs require extension of q over a complex domain. Thus, we translate variational inputs by a pre-determined constant bound, c=2 (1+1/K) log N, within the definitions:

$${V}_{m , k} = [ {U}_{: , {i}_{m}} - U φ ( {H}_{m , :} U ) + c ] {X}_{m , k , :} and \\ = [ log {E}_{{i}_{m} , :} - log {E}^{T} {\sum }_{j = 1}^{M} \frac{{Y}_{j , :}}{M} + c ] {X}_{m , k , :}^{T} .$$

The bound c can be understood as 2—since V is computed via differences of two vectors—times the product of the exponent derived from a model's priming number (K), with the maximum entropy from a uniform distribution over a vocabulary of size K, since the columns of U approximately equal log-probabiltiy distributions. Computationally, c appears to produce matrices F (QV) with positive values for all architectural variants tested. Intuitively, we understand the robustness of the SAFFU's explicit solution to V's translation by c (as defined), as a result of each vector in: U_{m,:}−Uφ(H_{m,:}U) being in the pre-image of the softmax function's prediction from a uniform feature-vector over the decoder U. Thus, the translation of each pre-image vector—and hence their difference—is an operation to which the softmax function input is invariant (scalar translation).

### 3.2.4 Assigning Low-Dimensional Input Vectors (Embeddings)

Standard-basis encoding underlies token representation in neural language processing, even when tokens are mapped sparsely to low-dimensional embeddings. While standard bases are excellent for representation from perspectives such as precision, simplicity, and transparency, their relatively high dimensionalities make dimensionality reduction necessary—standard bases scale poorly and over-fit to training data, to name a few issues. Dimensionality reduction can be handled via gradient-based optimization, but this approach is largely antithetical to our work's approach. Thus, we employ a naïve mathematical approach, that 1) selects a low dimension: D (a hyperparameter) and extends its set of standard basis vectors in the identity matrix: I∈ {0,1}^{D×D}, to a larger set of up to bit-vectors (See Sec. 1), in order of decreasing discernability, to rapidly train embedding matrices of unit-normalized bit-vectors to satisfy the SAFFU's representation requirements for E ∈(0,1]^{N×D}. Pseudocode is presented in FIG. 1.2 for the bit-cipher algorithm, which is applied in our assignment of bit-vectors in SAFFU model embedding layers to tokens, as well as to the training of low-dimensional ‘targets’ to train hidden layers in our description of the encoder-decoder, SAFFU-based transformer architecture presented in the next section.

The inventors likewise densify bit-vectors using a model of noise, much as in Sec. 2. This is done by computing a vector of token counts

$$f = {\sum }_{m = 1}^{M} {Y}_{m , :} ,$$

and then the average (un-noised) embedding:

$$\overline{e} = ( {\sum }_{n = 1}^{N} {f}_{n} {E}_{n , :} ) / M ,$$

and a model: q ∈(0,1)^{N} for the portion of occurrences that each n-token's observations are (non-) erroneous. Assuming that the highest-count tokens are least erroneously observed, we assume that only one error is observed relative to each token's count, that is: qₙ=fₙ/(fₙ+1). Next and regardless of the token that is observed, we modify its vector according to the probabilities that any different, j-token, should have been observed, instead, which will take the form of a normalized (|p|₁=1) noise vector: p∈ (0,1)^{N}, defined to be near-uniform as: p=(1−ē)/|1−ē|1. To understand p intuitively, we note that 1-minus each of the average embedding ē's (normalized) value is also a probability, which expresses the chance that a given dimension's magnitude is spurious (should not be observed). In application, the value of each bit-vector, E_{n,:}, is finalized by adding noise to rows of embedding layers: E_{n,:}=qₙ E_{n,:}+(1−qₙ) p.

### 3.3 A SAFFU-based Transformer Architecture

To define an LM and transformer architecture, we generally use two distinct SAFFUs, which are principally defined by hyperparameters referred to as the block size: b, and the radius: r. Both are positive integers greater than 1 that describe the number of features over which a SAFFU's attention layer operates. The block and radial SAFFUs use different definitions of context for input tensors, denoted by X^{block} and X^{radius}. The value b defines the number of tokens per input block for self-attention. Specifically, consider collecting a document's M_{doc} tokens in the tensor B ∈ R^{Mdoc/(b-1)×b×D} by assigning each m=1, . . . , M_{doc} to block i=m/(b−1) by the equation

$${B}_{i , 2 : b , :} = {[ {E}_{{i}_{j} , :} ]}_{j = ( i - 1 ) ( b - 1 ) + 1}^{i ( b - 1 ) + 1} .$$

These input embeddings are broken into slices of b−1 so as to accommodate room for special tokens that further contextualize input, by indicating if it is the first block or a later one. All blocks have their first input β_{i,1,:} set to an embedding for a start of document token: “<sod>” (for the first block), or to an embedding for a fragment token: “<frg>” (for other blocks). Padding tokens: “<pad>” fill the remaining positions of the last block with features, the last of which is reserved for an end of document token's: “<eod>” embedding.

Slices of the block-input tensor are assigned according to the equation:

$${X}_{m , : , :}^{block} = {B}_{i , : , :} .$$

To assure that each slice

$${x}_{m , : , :}^{block}$$

contains no target information (Y_{m,:}), inputs appearing at or beyond the target's position within the block are replaced by those for padding tokens. While

$${x}_{m , : , :}^{block}$$

provides a global information on feature positions, the radius r is local, i.e., has a sliding horizon of r features for each target. Denote the m^{th} target's position within block i by j, and define the r-input radial features as those appearing before the m^{th}:

$${X}_{m , : , :}^{radius} = {B}_{i , ( j - 1 - r ) : ( j - 1 ) , :} .$$

For targets at positions m<r (without a complete radius), missing features are filled with “<pad>” embeddings. Much like in Sec. 2, each block and radius SAFFU can be operated under two modes of vector aggregation: summation-based aggregation (sum) models add attention-weighted input vectors, and concatenation-based (cat) models concatenate their attention-weighted input vectors. Note: cat models form hidden states in R^{KD} (vs. R^{D}) and so incur a K-fold increase decoder-parametric complexity: U^{cat} ∈ R^{KD×N}. This is controlled by setting separate embedding dimensions for each of the block and radial SAFFU's inputs: D_{b}=2⁷ and Dᵣ=2⁵ for all experiments, keeping these experiments' ‘best’ models under 10-million parameters. Note: early experimentation uniformly demonstrated that bit-cipher embeddings smoothly offset performance with size, which—alongside the clear ‘best’ configuration of sum-based block and cat-based radius aggregation—meant computational gains could be made by lowering parameter-intensive cat dimensions.

For an encoder-decoder architecture, we require that both block and radial SAFFUs have their outputs reduced to a ‘low’ hidden dimension: D_{H}<N. This is accomplished by dimensionally reducing both block- and radius-SAFFU targets in explicit solutions from Y to the matrix \tilde{Y}∈ R^{M×DH} defined by: \tilde{Y}_{m,:}=Zᵢ_{ₘ}_{,:}. Here, Z is a matrix of bit-vectors—serving as low-dimensional/hidden targets—from the bit-cipher algorithm depicted in FIG. 1.2. Block and radial outputs are then concatenated and decoded (again) by a final feed-forward layer: M∈ R^{2DH×N}. A full architectural diagram for this design is presented at left in FIG. 3.1, where the top and bottom flows depict block and radial SAFFUs operating on sequentially ordered (from top to bottom), globally- and locally-positioned vectors (black rectangles). After products are taken with the head vector (depicted in yellow), quadratic features are passed to self-attention layers, which output positional weights (depicted in gray) to produce aggregate embeddings. Aggregates are fed through their decoders to produce concatenated outputs from the two SAFFUs, before being fed forward to the target distribution size. Thus, the last layer is the decoder, and all preceding layers comprise the encoder.

3.3.1 Augmenting Transformers with Document Models

To better contextualize a given transformer's outputs, we likewise define an optional document model, which outputs its own hidden state via an intermediate single-layer prediction. We assume that there are A documents, and that the m^{th} token in document δ of length M_{δ} has its input to the document model defined by the average of all preceding embeddings (plus one for a padding token):

$$x = ( {E}_{{i}_{< pad >} , :} + {\sum }_{i = 1}^{m - 1} {E}_{{i}_{j} , :} ) / m .$$

Each vector x is passed through a feed-forward model whose parameter matrix we denote by D∈ R^{D×Δ} that predicts the document index δ from which x came. When a document model is used with a SAFFU-based transformer, each of its outputs: φ(xD) is concatenated to the result from the two SAFFU's, i.e., φ(xD) is concatenated to the red-blue result prior to the last feed-forward layer, M, whose input dimensionality is augmented to: R^{(2DH+A)×N}.

### 3.4 Computational Experiments

Data. The inventors perform all ablation—and other, larger experiments—on a recently-released data set, known as the BabyLM data set. These data have two main training sets, consisting of 10-(10 M) and 100-million (100 M) tokens, and likewise contain 10-million token sets for development and testing. For speed and efficiency, the ablation used the first 10% (roughly 106 tokens) of the 10 M training set.

Tokenization. The inventors use sub-word tokenizations to benefit from the efficiency, simplicity, and speed of a count-based implementation of byte-pair encoding (BPE). BPE is used to train two tokenization models over the 217 and 220 highest-count words contained in the 10 M- and 100 M-word BabyLM data sets, respectively until the stopping condition: all new merge rules produce a new sub-word token of count 1 is reached. All experiments had their vocabulary size further reduced by replacing sub-word tokens not needed for tokenization of the 2¹² highest count words. This reduced the 10 M-token sub-word vocabulary size to a functional set of N^{10M}=2,848 (down from 26,693) sub-word tokens, which added large efficiency boosts to ablation time. However, we note that these ablation efficiency boosts were only achieved during backpropagation, since computing explicit solutions doesn't require operation of the final softmax, which is bottlenecked by a normalization over the vocabulary size N. The 100 M-token model's vocabulary was also reduced, but from 20,590 to N^{100M}=2,755, which thus demonstrated a much higher compression ratio over its 220 words, when compared to the 10 M model's same-sized covering by 2,755 sub-words, down from 20,590.

Training. Experiments were trained over 1-million token folds of the 10 M- and 100 M-token sets. Backpropagation experiments used Adam for optimization with a learning rate of 10⁵/2 across experiments. Ablation experiments use absolutely no backpropagation, and received only 10% of the 10 M-token data via initialization, defined as: having embedding matrices initialized by the bit-cipher algorithm, self-attention matrices initialized by the explicit solution initialization targets, \hat{V}, and then followed by successive application of explicit solution computations to all subsequent feed-forward/decoder layers, from the bottom up. In larger experiments, we refer to cold-start models as those which have had random parameter initialization followed by backpropagation applied to all layers. Cold-starts are compared to warm-start models, which have had initialization by \hat{V} (on the first fold) followed by tuning. The inventors distinguish tuning from initialization only by use of V over \hat{V}. Tuning is applied over 10 folds (10-million tokens) for both 10 M- and 100 M-token models. While the 10 M/former models used V instead of \hat{V} over 10 iterations, the 100 M-token model was initialized in a single 10-million token shot, i.e., it was only initialize with 10% of the larger data set before backpropagation. Following 10-million tokens warm-start, backpropagation was applied to all but the embedding layers of warm-start models, until early stopping is signaled by 23 increases in perplexity, which was measured on approximately 10⁵ tokens from the development set, regardless of model size. Early stopping determines the total number of cold-start epochs, and we refer to non-altered bit-cipher embeddings as frozen, whose results are discussed in the next section.

### 3.5 Experimental Results

The explicit solution's efficiency and stability allowed ablation of many SAFFU model variants. All—approximately 250—have their performance presented in Tables 3.1-3.5. These explore combinations of the proposed sum and cat architectural variations on each of the block and radial SAFFUs (Tabs. 3.1-3.4), and then the impact of the document model on top of the ‘best’ combination (with lowest-perplexity models), which turned out to use sum for blocks and cat for radii (Tab. 3). Each table represents an r-b ‘grid’ corresponding to powers of 2, i.e., with r, b∈ {2¹, 2², . . . , 2⁷}. Tables 3.1-3.5 can be seen as a basis for determination of which architectural variants merited further training. For planning larger-scale models, perplexities may more or less generally decrease with larger values of r and b across tables, as this indicates that adding more features improves prediction. However, we note some local optima appear for smaller values of r when its ‘best’ cat-based aggregation is used, providing a balance of efficiency and performance. While cat-based block aggregation is less advantageous, we note that it likewise has worse optima.

The ‘best’ architecture from Tab. 3.5 (the black curve in FIG. 3.1), at the high-efficiency optimum of r=2³ kept blocks large: b=2⁷, still capture long-range correlations. Setting r=2³ ultimately resulted in models with more robust learning curves, optimizing for more epochs before the early-stopping criterion was reached than when r=2⁷ (FIG. 3.1, red curve). Aside from ablation successfully guiding model experimentation, it is perhaps the biggest surprise to see that cold-start models fail to optimize to anywhere near the level of performance that warm-start models do, as can be seen in the gray and pink curves in FIG. 3.1. While it is perhaps not surprising that fewer parameters contributed to greater robustness during backpropagation, there would likely have been no impetus to investigate the more-performant (and efficient) r=23 model if our experiment not identified the near-parity between r=2³ with r=2⁷ in ablation. Ultimately, r=2³ achieved the best test perplexity of 23.84, while the r=2⁷ model's perplexity only fell to 30.35 and the 10 M cold-start models reached 63.98 (both), and our initial 100-million token model with r=2³ and b=2⁷, surprisingly, stopped at 58.05 (blue in FIG. 3.1), despite having been trained on the most individual documents.

### 3.6 Discussion

Ablation-based determination of ‘best’ models for backpropagation greatly benefited from using few tokens, which was possible due to the deterministic nature of explicit solutions and their initialization by zero-matrices. Tuning models beyond ablation improved performance; however, initializing over just 1-million tokens with the explicit solution demonstrated balanced performance on a random development set. For the 100-million token model (blue in FIG. 3.1), this motivated a simplified training process that applied backpropagation immediately after its initialization over 10-million tokens in a single pass. These 10% of the 100 M model's training data appeared insufficient for warming the model up to learning from all 100 M tokens. This resulted in demonstrably less stable backpropagation, when compared to the faster-to-optimize 10 M-models. Hence, having a broader ‘foundation’ with more data used in the explicit solution could be key to stable learning and generalization.

Several new algorithms were required to satisfy the strict conditions defined by our work, but, when taken as a whole—with this work's computational experiments demonstrating warm-start optimality unachievable without explicit solutions—this work shows that when iterative optimization and explicit solutions are combined, they can lead to neural optimizations that were previously un-achievable over such marginal scales of data. The derived explicit solutions at present only work well, meaning that while they drastically reduce the training costs networks, they still may be followed by some iterative optimization using backpropagation. The presented explicit solutions do make it possible to optimize a given network's performance to a point that is far beyond what's possible for networks with parameters that were initialized randomly.

### 3.6.1 Conclusion

While training bigger models, the inventors noted how the 10 M data—which was fully used in its explicit solution applications—was better used during backpropagation before early stopping, optimizing models more effectively over multiples passes of relatively few data. Alongside this smoother optimization, what's truly striking about is that training over multiple passes on small samples of data was more effective than access to more data (for fewer passes). So, while one might expect the 100 M-token data to produce better models, it may be the case that they need to be trained over for longer periods, and perhaps have the explicit solution used over all 100 M tokens. Understanding this phenomenon further may be relevant for future applications of the SAFFU architecture and its explicit solution, but the best scenario for future development is likely if explicit solutions can be derived that entirely obviate the need for backpropagation. Regardless, since explicit solutions seem to work well with less data, they hold potential for the future development of high-performance LMs that moreover, are small, and which could learn on-site using localized data for applications of embodiment. These findings demonstrate the potential of explicit solutions for efficiently training complex and multi-layer models, and we hope this work encourages further exploration of explicit solutions as a strategy for improving training efficiency and our understanding of model function.

### 3.7 Appendix/Supplementary Material

### 3.7.1 Deriving the SAFFU's Optimization Criteria

### 3.7.1.1 Deriving an Optimization Criterion for the Decoder Layer

Consider the partial derivatives of L with respect to each parameter of the decoder layer, U_{j,i}:

$$\frac{\partial L}{\partial {U}_{j , i}} = {\sum }_{m = 1}^{M} [ {Y}_{m , i} - φ {( {H}_{m , :} U )}_{i} ] {H}_{m , j} = {F ( H , Y )}_{j , i} - {\sum }_{m = 1}^{M} φ {( {H}_{m , :} U )}_{i} {H}_{m , j} \qquad EQ . 3.5$$

To derive these, it is helpful to recall the SAFFU's notational conventions (slices of matrices) for its M attention distributions: A_{m,:}=−log φ(WX_{m,h,:}X_{m,:,:}) and hidden states: H_{m,:}=A_{m,:}X_{m,:,:}.

Upon setting the derivative equal to 0, we then note that any optimum of the decoder must have its action over hidden states produce probabilities with expected values equal to the column-conditional probabilities of the co-occurrence distribution normalized by

$${\sum }_{n = 1}^{N} {F ( H , Y )}_{j , n} = {\sum }_{n = 1}^{M} {H}_{n , j} :$$

$$\frac{{F ( H , Y )}_{j , i}}{{\sum }_{n = 1}^{N} {F ( H , Y )}_{j , n}} = {\sum }_{m = 1}^{M} φ {( {H}_{m , :} U )}_{i} \frac{{H}_{m , j}}{{\sum }_{n = 1}^{N} {F ( H , Y )}_{j , n}} = E φ {( {H}_{m , :} U )}_{i} \qquad EQ . 3.6$$

In other words, one arrives at the same conclusion about the compositional decoder as was made from analysis of the single-layer decoder: the arithmetic average prediction of the model on target i, taken over the j-hidden frequencies, will behave as the conditional probability of the outputs, given the inputs. With this is established, we must ask the question: what distributional form will in the inputs take? This is partly answered by taking derivatives with respect to the ‘deep’ (attention) layer.

### 3.7.1.2 Deriving an Optimization Criterion for the Self-Attention Layer

Once can similarly take the partial derivatives with respect to the attention layer's, parameters W_{j,i}:

$$\frac{\partial L}{\partial {W}_{j , i}} = {\sum }_{m = 1}^{M} [ {U}_{: , {i}_{m}} - {\sum }_{n = 1}^{N} {U}_{: , n} φ {( {H}_{m , :} U )}_{n} ] \cdot \frac{\partial {H}_{m , :}}{\partial {W}_{j , i}} \qquad EQ . 3.7$$

The compositional relationship between the decoder and attention layers is defined by an inner product of hidden state partial derivatives with a decoder-based expression (that we will return to shortly). Note: this relationship is invariant to activation functions, and would be expressed in precisely the same manner for compositional optimization of ‘deep’ layers. The hidden-state vectors produce partials derivatives of vectors, too, when L's partial is taken over the parameter W_{j,i}:

$$\frac{\partial {H}_{m , :}}{\partial {W}_{j , i}} = {\sum }_{k = 1}^{K} {X}_{m , k , :} {Q}_{m , j} [ {e}_{k}^{( i )} - φ {( {Q}_{m , :} W )}_{i} ] \qquad EQ . 3.8$$

where e⁽ⁱ⁾ is the standard basis vector of dimension K with 1 at position i. To express a solution for W, it next helps to define the tensor V∈ R^{M×K}, containing the information from variational vectors that describe the relative sensitivity of the decoder layer to each m^{th} instance of the training set's k=1, . . . , K features in X:V_{m,k}=[U_{:,i}_{ₘ}−Uφ(H_{m,:} U)]·X_{m,k,:}. Combining V with EQs. 3.7 and 3.8 simplifies the attention layer's partial derivatives:

$$\frac{\partial L}{\partial {W}_{j , i}} = {\sum }_{m = 1}^{M} {Q}_{m , j} [ {V}_{m , i} - φ {( {Q}_{m , :} W )}_{i {\sum }_{k = 1}^{K} {V}_{m , k}} ] \qquad EQ . 3.9$$

Thus, solving ∂L/∂W_{j,i}=0 allows for terms to be re-arranged and a—surprisingly familiar—condition on the point of the attention layer's optimization to be resolved:

$$\frac{{F ( Q , V )}_{j , i}}{{\sum }_{k = 1}^{K} {F ( Q , V )}_{j , k}} = {\sum }_{m = 1}^{M} φ {( {Q}_{m , :} W )}_{i} \frac{{Q}_{m , j {\sum }_{k = 1}^{K} {V}_{m , k}}}{{\sum }_{k = 1}^{K} {F ( Q , V )}_{j , k}} = E φ {( {Q}_{m , :} W )}_{i} \qquad EQ . 3.1$$

Specifically, if (a big if) the values

$$[ {Q}_{m , j {\sum }_{k = 1}^{K} {V}_{m , k}} ] / [ {\sum }_{k = 1}^{K} {F ( Q , V )}_{j , k} ]$$

constitute a probability mass function over the training set's M instances of prediction, our conclusion is a statement much like for the SAFFU's decoder, where we observed an equivalent premise to the single-layer model's explicit solution: the arithmetic average prediction-now a feature weight—of the attention layer on feature i, taken over the j-input co-frequencies with quadratic values in Q will behave as the conditional probability of the outputs, given the inputs. As mentioned for the decoder, we must ask: what distributional form will in the inputs take? It should now be clear that neither the inputs, H_{m,:}, for the decoder-nor the inputs, Q_{m,:}, to the attention layer—have unit sum. Thus, estimates will need to be made for both layers' priming numbers in order to complete their optimizations.

Note that this investigation glosses over a subtle and perhaps exciting point of observation—that we can now answer: what self-attention's supervising targets are. While we intentionally consolidated the attention layer's inputs under the form Q it is a marvel—whether by serendipity or the need for concise notation—that the matrix V emerged. Intuitively, it contains variational information on the decoder summarizing what the attention-matrix W should expect from U's reactions to its (W's) activations. In summary, the co-optimal criteria for the matrices U and W in EQs. 3.6 and 3.10 ultimately allow us to see that V contains the differentially-guiding targets of the self-attention layer, W. Thus, the input-output pair of matrices Q and V are to W, as H and Y are to U.

### EMBODIMENTS

Embodiment 1. A word representation system generated from a dimensionality-reduction method that sets arbitrary, low-dimensional sequences of bit vectors to different categories being used as features and target labels of prediction, comprising the steps:
1) initializing computing token (word) counts and fixing a vocabulary size N (number of unique tokens);
2) fixing a number of bits, B, which number of bits correspond to a dimensionality of representation, reduced from N to as few as the ceiling of log 2 N dimensions;
3) assigning, by decreasing count, the B (standard basis) vectors of norm b=1 to the B highest count tokens;
4) traversing and individually assigning subsequent bit vectors to the remaining N−B tokens by:
4a) adding standard basis vectors to b−1 norm bit vectors to generate untraversed b-bit vectors;
4b) assigning untraversed bit b-bit vectors to the next highest count token;
5) wherein the steps terminate when all N tokens have been assigned a bit vector.

Embodiment 2. A method for locally optimizing layers of neural networks comprising the steps of:
(1) for the input layer (layer L=1) of the neural network, computing a generalized co-occurrence matrix between the input level of the neural network's K input vectors per output as a supervising target and a representation of the output, wherein the representation may be dimensionally-reduced;
(2) re-normalizing each output dimension of layer L's co-occurrence matrix by the output dimension's sum raised to the (k−1)/k power and completing a training of the input layer by taking a logarithm of the result of the renormalization;
(3) to train layer L, performing matrix multiplication and softmax-function activation on each layer of 1, . . . , L−1's input or hidden-state vectors, the last of which include layer L's hidden states (inputs), wherein the hidden states are then used to compute layer L's generalized co-occurrence matrix between the hidden states and representation of the outputs (supervising targets);
Repeating steps 2 and 3 until all layers are trained.

Embodiment 3. A method for compositionally optimizing feed-forward layers of neural networks with feature-consolidated self-attention layers comprising the steps of:
1) to start up the self-attention layer W of the neural network, computing a generalized co-occurrence matrix between a feature-weighted signed deviation of the network's embedding layer with its mean word vector in the event that there is an embedding layer and the model's K-dimensional consolidated quadratic features, which include inner products between each target's K D-dimensional feature vectors with one head vector, wherein in the event that there is no embedding layer and/or if the embedding dimension is different from the decoder's hidden state, then the self-attention layer uniformly, as a matrix of 1s, is started up;
2) re-normalizing each output dimension of the self-attention layer's generalized co-occurrence matrix by its sum raised to the (k−1)/k power, and then completing the self-attention layer's training by taking the logarithm of the result;
3) to update the feed-forward layer U of the neural network, augmenting the generalized co-occurrence matrix over more data by adding generalized co-occurrences, taken between the target vectors of prediction and the self-attended (by W's output) features, i.e., that are self-attention-weighted aggregations of each target's K features;
4) repeating step (2) with the matrix U;
5) to update the self-attention layer W, augmenting W's the generalized co-occurrence matrix over more data by adding more generalized co-occurrences, taken between the feature-weighted signed deviation of the network's decoder layer U for each target of prediction with U's mean output vector and the model's K-dimensional quadratic features, which consist of inner products between each target's K D-dimensional feature vectors with one head vector;
6) repeating step (2) with the matrix W; and
7) repeating steps 3-6 until a stopping criterion is reached and/or if all data is utilized.

Embodiment 4. A natural language generation and interpretation system that guides users to source data through personalized filters, training the system to generate natural language sequences and labels for arbitrary output vocabularies, including in response to arbitrary input sequences; the system's methods comprises the following steps:
a tokenizer that tokenizes a sequence of linguistic symbols into tokens that use a distributionally regularized byte pair encoding algorithm;
a semantic representation and transfer learning algorithm that sets a fixed-dimensional statistical vector for the meaning(s) associated to each token and label;
a dimensionality-reduction algorithm that sets arbitrary, low-dimensional sequences of bit vectors to the different categories being used as features and target labels of prediction;
a positional representation algorithm that organizes both independent or dependent statistics for token positions, and utilizes a token-wave model to smooth locality;
a bias control framework that filters data for models to personalize what they learn and in turn interpret and express via natural language predictions and responses; and
a sequence-to-sequence learning architecture that uses one sequence as features to predict the corresponding semantics and tokens in the other sequence's order.

Embodiment 5. The system of embodiment 4, wherein the tokenizer: takes the base sequence of character symbols as input and iteratively evaluates and ranks merge- and split-rules between pairs of characters- and subsequently, multi-character compounds—to form tokens, whose statistical abundance minimize the normalized lexical entropy of the resultant vocabulary's usage, measured against variations of harmonic (power-law) statistical distributions.

E Embodiment 6. The system of embodiment 5, wherein the semantic representation learning algorithm: measures the local abundance (co-occurrence) of tokens and their labels within each other's vicinities, as defined by a ‘sliding window’ of radius r, i.e., where the abundance of the immediate+r (at most) tokens surrounding any given token and its labels is enumerated, wherein co-occurrence values are then imputed for un-observed (non-occurrent token pairs), which when taken with the enumerated co-occurrences forms a separate matrix of co-occurrences between the tokens and any output set (tokens or labels), wherein each such matrix is then normalized (marginalized) with respect to its output set by taking the quotient of each row (as a vector) with its sum,; wherein the logarithm of each such matrix then constitutes a representation system, capable of encoding contexts (co-occurring tokens) into an entropic representation for decoding and generation, and/or factorization, creating ‘token vector’ features for downstream NLP tasks.

Embodiment 7. The system of embodiment 4, wherein the dimensionality direction algorithm: accepts the measured abundance of target labels and assigns normalized low dimensional (b-dimensional) vectors of bits in the order of 1) standard basis vectors, 2) unique sums of standard basis vectors, and 3+) unique sums of standard basis vectors with the previously generated bit-vectors.

Embodiment 8. The system of embodiment 4, wherein the positional representation algorithm: uses an aggregation of feature-token representations via summation (independence) or concatenation (dependence) with smoothing provided by a sinusoidal token-recurrence model.

Embodiment 9. The system of embodiment 4, wherein the bias control framework: receives a representative collection of analogies to describe a demographic disparity, such as binary gender, 2-party politics, sentiment, or any other bi-polar, user-defined (and—represented) disparity, such as cats (X) vs. dogs (Y), wherein interactions with personal analogies and their harmonic presence in data provide a filtration signal for desired ‘bias’, allowing trainers prioritization in the filtration of training data (text) on X-related subjects over Y-related subjects to support an X-specific community need for natural language generation and interpretation.

Embodiment 10. The system of embodiment 4, wherein the sequence-to-sequence architecture: learns from data whose instances comprise two-sequence pairs (source-s and target-t), such that for each token i of Mt in the target, r-radius patches from the Ms source tokens surrounding (and including) token j=round(iMs/Mt)−the ±r (at most) tokens surrounding j in s have labels enumerated and counted against the target token i for co-occurrent contexts and representations, and applying these statistics for sequence-to-sequence generation.

While the invention has been described with reference to the embodiments above, a person of ordinary skill in the art would understand that various changes or modifications may be made thereto without departing from the scope of the claims. The reference to the first person plural we and our herein is often meant to refer to the inventors, although in some cases, it refers to the reader as the audience, depending on the context.

We claim:

1. A word representation system generated from a dimensionality-reduction method that sets arbitrary, low-dimensional sequences of bit vectors to different categories being used as features and target labels of prediction, comprising the steps:
1) initializing computing token (word) counts and fixing a vocabulary size N (number of unique tokens);
2) fixing a number of bits, B, which number of bits correspond to a dimensionality of representation, reduced from N to as few as the ceiling of log 2N dimensions;
3) assigning, by decreasing count, the B (standard basis) vectors of norm b=1 to the B highest count tokens;
4) traversing and individually assigning subsequent bit vectors to the remaining N−B tokens by:
4a) adding standard basis vectors to b−1 norm bit vectors to generate untraversed b-bit vectors;
4b) assigning untraversed bit b-bit vectors to the next highest count token;
5) wherein the steps terminate when all N tokens have been assigned a bit vector.

2. A method for locally optimizing layers of neural networks comprising the steps of:
(1) for the input layer (layer L=1) of the neural network, computing a generalized co-occurrence matrix between the input level of the neural network's K input vectors per output as a supervising target and a representation of the output, wherein the representation may be dimensionally-reduced;
(2) re-normalizing each output dimension of layer L's co-occurrence matrix by the output dimension's sum raised to the (k−1)/k power and completing a training of the input layer by taking a logarithm of the result of the renormalization;
(3) to train layer L, performing matrix multiplication and softmax-function activation on each layer of 1, . . . , L−1's input or hidden-state vectors, the last of which include layer L's hidden states (inputs), wherein the hidden states are then used to compute layer L's generalized co-occurrence matrix between the hidden states and representation of the outputs (supervising targets);
Repeating steps 2 and 3 until all layers are trained.

3. A method for compositionally optimizing feed-forward layers of neural networks with feature-consolidated self-attention layers comprising the steps of:
1) to start up the self-attention layer W of the neural network, computing a generalized co-occurrence matrix between a feature-weighted signed deviation of the network's embedding layer with its mean word vector in the event that there is an embedding layer and the model's K-dimensional consolidated quadratic features, which include inner products between each target's K D-dimensional feature vectors with one head vector, wherein in the event that there is no embedding layer and/or if the embedding dimension is different from the decoder's hidden state, then the self-attention layer uniformly, as a matrix of 1 s, is started up;
2) re-normalizing each output dimension of the self-attention layer's generalized co-occurrence matrix by its sum raised to the (k−1)/k power, and then completing the self-attention layer's training by taking the logarithm of the result;
3) to update the feed-forward layer U of the neural network, augmenting the generalized co-occurrence matrix over more data by adding generalized co-occurrences, taken between the target vectors of prediction and the self-attended (by W's output) features, i.e., that are self-attention-weighted aggregations of each target's K features;
4) repeating step (2) with the matrix U;
5) to update the self-attention layer W, augmenting W's the generalized co-occurrence matrix over more data by adding more generalized co-occurrences, taken between the feature-weighted signed deviation of the network's decoder layer U for each target of prediction with U's mean output vector and the model's K-dimensional quadratic features, which consist of inner products between each target's K D-dimensional feature vectors with one head vector;
6) repeating step (2) with the matrix W; and
7) repeating steps 3-6 until a stopping criterion is reached and/or if all data is utilized.

4. A natural language generation and interpretation system that guides users to source data through personalized filters, training the system to generate natural language sequences and labels for arbitrary output vocabularies, including in response to arbitrary input sequences; the system's methods comprises the following steps:
a tokenizer that tokenizes a sequence of linguistic symbols into tokens that use a distributionally regularized byte pair encoding algorithm;
a semantic representation and transfer learning algorithm that sets a fixed-dimensional statistical vector for the meaning(s) associated to each token and label;
a dimensionality-reduction algorithm that sets arbitrary, low-dimensional sequences of bit vectors to the different categories being used as features and target labels of prediction;
a positional representation algorithm that organizes both independent or dependent statistics for token positions, and utilizes a token-wave model to smooth locality;
a bias control framework that filters data for models to personalize what they learn and in turn interpret and express via natural language predictions and responses; and
a sequence-to-sequence learning architecture that uses one sequence as features to predict the corresponding semantics and tokens in the other sequence's order.

5. The system of claim 4, wherein the tokenizer: takes the base sequence of character symbols as input and iteratively evaluates and ranks merge—and split-rules between pairs of characters—and subsequently, multi-character compounds—to form tokens, whose statistical abundance minimize the normalized lexical entropy of the resultant vocabulary's usage, measured against variations of harmonic (power-law) statistical distributions.

6. The system of claim 5, wherein the semantic representation learning algorithm: measures the local abundance (co-occurrence) of tokens and their labels within each other's vicinities, as defined by a ‘sliding window’ of radius r, i.e., where the abundance of the immediate±r (at most) tokens surrounding any given token and its labels is enumerated, wherein co-occurrence values are then imputed for un-observed (non-occurrent token pairs), which when taken with the enumerated co-occurrences forms a separate matrix of co-occurrences between the tokens and any output set (tokens or labels), wherein each such matrix is then normalized (marginalized) with respect to its output set by taking the quotient of each row (as a vector) with its sum,; wherein the logarithm of each such matrix then constitutes a representation system, capable of encoding contexts (co-occurring tokens) into an entropic representation for decoding and generation, and/or factorization, creating ‘token vector’ features for downstream NLP tasks.

7. The system of claim 4, wherein the dimensionality direction algorithm: accepts the measured abundance of target labels and assigns normalized low dimensional (b-dimensional) vectors of bits in the order of 1) standard basis vectors, 2) unique sums of standard basis vectors, and 3+) unique sums of standard basis vectors with the previously generated bit-vectors.

8. The system of claim 4, wherein the positional representation algorithm: uses an aggregation of feature-token representations via summation (independence) or concatenation (dependence) with smoothing provided by a sinusoidal token-recurrence model.

9. The system of claim 4, wherein the bias control framework: receives a representative collection of analogies to describe a demographic disparity, such as binary gender, 2-party politics, sentiment, or any other bi-polar, user-defined (and -represented) disparity, such as cats (X) vs. dogs (Y), wherein interactions with personal analogies and their harmonic presence in data provide a filtration signal for desired ‘bias’, allowing trainers prioritization in the filtration of training data (text) on X-related subjects over Y-related subjects to support an X-specific community need for natural language generation and interpretation.

10. The system of claim 4, wherein the sequence-to-sequence architecture: learns from data whose instances comprise two-sequence pairs (source-s and target-t), such that for each token i of Mt in the target, r-radius patches from the Ms source tokens surrounding (and including) token j=round (iMs/Mt)−the ±r (at most) tokens surrounding j in s have labels enumerated and counted against the target token i for co-occurrent contexts and representations, and applying these statistics for sequence-to-sequence generation.
